(19) United States
(12) Patent Application Publication
(10) Pub. No.: US 2025/0150118 A1
(43) Pub. Date: May 8, 2025

(54) RECONFIGURABLE INTELLIGENT SURFACE MANAGEMENT IN WIRELESS SYSTEMS

(71) Applicant: Lenovo (Singapore) Pte. Limited, Singapore (SG)

(72) Inventors: Ali Ramadan Ali, Kraiburg (DE); Karthikeyan Ganesan, Kronberg Im Taunus (DE); Soumya Somasekharan Nambiar, Aachen (DE); Ravi Kuchibhotla, Chicago, IL (US)

(73) Assignee: Lenovo (Singapore) Pte. Limited, Singapore (SG)

(21) Appl. No.: 18/839,999

(22) PCT Filed: Feb. 16, 2023
(86) PCT No.: PCT/IB2023/051421

§ 371 Date: Aug. 20, 2024

Related U.S. Application Data
(60) Provisional application No. 63/312,364, filed on Feb. 21, 2022.
(60) Provisional application No. 63/312,368, filed on Feb. 21, 2022.

(51) Int. Cl. H04B 7/04

(52) U.S. Cl. CPC H04B 7/04013

(57) ABSTRACT

The present disclosure relates to methods, apparatuses, and systems that support reconfigurable intelligent surface (RIS) management in wireless systems. For instance, aspects of the disclosure enable operational aspects of an RIS to be controlled to reduce signal interference caused by operation of the RIS. Aspects of the disclosure also enable RIS control to be allocated between different base stations, such as to enable base stations to access an RIS for providing signal communication for UEs served by the base stations.

### RELATED APPLICATION

This application claims priority to U.S. Patent Application Ser. No. 63/312,364 filed 21 Feb. 2022 and entitled “RECONFIGURABLE INTELLIGENT SURFACE MANAGEMENT IN WIRELESS SYSTEMS,” and U.S. Patent Application Ser. No. 63/312,368 filed 21 Feb. 2022 and entitled “RECONFIGURABLE INTELLIGENT SURFACE MANAGEMENT IN WIRELESS SYSTEMS,” the disclosures of which are hereby incorporated by reference herein in their entirety.

### TECHNICAL FIELD

The present disclosure relates to wireless communications, and more specifically to reconfigurable intelligent surfaces.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Wireless communications systems utilize different types and configurations of antenna systems for enabling wireless signal communication. For instance, base stations implement antenna systems configured to provide wireless signal service in a surrounding area. However, depending on antenna placement and/or position of UEs in a surrounding area, antenna systems can cause signal interference that can degrade wireless performance of a UE.

### SUMMARY

The present disclosure relates to methods, apparatuses, and systems that support reconfigurable intelligent surface (RIS) management in wireless systems. For instance, aspects of the disclosure enable operational aspects of an RIS to be controlled to reduce signal interference caused by operation of the RIS. In an example implementation, a first base station that provides wireless connectivity to a UE determines that the UE is experiencing signal quality degradation that may be caused by operation of an RIS. Accordingly, the first base station communicates with a second base station that controls the RIS to implement a procedure to determine if the RIS is causing signal interference, and if so, modify operation of the RIS to attempt to mitigate the signal interference.

Aspects of the disclosure also enable RIS control to be allocated between different base stations, such as to enable base stations to access an RIS for providing signal communication for UEs served by the base stations. For instance, a first base station determines that UEs connected to the base station are experiencing signal quality problems. Accordingly, the first base station implements a process to obtain access to an RIS to attempt to enhance signal quality for its UEs. As part of this process, for example, the first base station negotiates connectivity to an RIS that is controlled by a second base station. Utilizing the connected RIS, the first base station can enable wireless signal communication between its UEs and the first base station via the connected RIS. Accordingly, by utilizing the described techniques, RIS control can be utilized to reduce signal interference experienced at UEs and to increase UE signal quality.

Some implementations of the method and apparatuses described herein may include wireless communication at a device (e.g., a base station), and the device receives a first notification including a first indication of signal interference and first RIS configuration information; generates second RIS configuration information based at least in part on the first RIS configuration information, and configures operation of an RIS based on the second RIS configuration information; receives a second notification including a second indication of signal interference; and configures operation of the RIS based at least in part on the second indication of signal interference.

In some implementations of the method and apparatuses described herein, the first indication of signal interference includes one or more of an indication of an amount of signal interference, an indication of a coverage area affected by the signal interference, or a direction of one or more interfering signals; where the first RIS configuration information includes a power reduction request to be applied to the RIS; where the first RIS configuration information includes an OFF pattern to be applied to the RIS; where the first notification is received from a network node, and generating third RIS configuration information that includes an OFF pattern of the RIS, and transmitting the third RIS configuration information to the network node; where the first RIS configuration information includes an OFF pattern to be applied to the RIS, and generating the second RIS configuration information to identify one or more time slots to be switched OFF by the RIS.

In some implementations of the method and apparatuses described herein, the second RIS configuration information is generated to include coefficients to apply signal absorption at the one or more time slots and based on the OFF pattern; where the first indication of signal interference includes one or more of an indication of a coverage area affected by the signal interference or a direction of one or more interfering signals, and generating the second RIS configuration information to include a coefficients update to be applied by the RIS to reduce signal interference at the one or more of the coverage area affected by the signal interference or the direction of the one or more interfering signals; where the first indication of signal interference includes one or more of an indication of a coverage area affected by the signal interference or a direction of one or more interfering signals, and generating the second RIS configuration information to include a power reduction instruction to be applied by the RIS to reduce signal interference at the one or more of the coverage area affected by the signal interference or the direction of the one or more interfering signals.

Some implementations of the method and apparatuses described herein may include wireless communication at a device (e.g., a base station), and the device receives from a UE a first measurement report including a first indication of signal interference; generates first RIS configuration information and transmitting, to a second network node, a first notification that includes the first indication of signal interference and the first RIS configuration information; generates signal measurement configuration information based at least in part on the first RIS configuration information, and transmits the signal measurement configuration information to the UE; receives from the UE a second measurement report including a second indication of signal interference based on applying the signal measurement configuration information at the UE; and generates a second notification that includes the second indication of signal interference, and transmit the second notification to the second network node.

In some implementations of the method and apparatuses described herein, the device generates, based on the first indication of signal interference, the first notification to include one or more of an indication of an amount of signal interference, an indication of a coverage area affected by the signal interference, or a direction of one or more interfering signals; generates the first RIS configuration information to include a power reduction request to be applied to an RIS; generates the first RIS configuration information to include an OFF pattern to be applied to an RIS; receives from the second network node an indication of an OFF pattern identifying time slots at which an RIS is in an OFF state; and generates the signal measurement configuration information based on the indication of the OFF pattern; generates the signal measurement configuration information to include an instruction for the UE to measure signal interference based on the OFF pattern to indicate signal interference detected when the OFF pattern indicates that the RIS is OFF and signal interference detected when the OFF pattern indicates that the RIS is ON; where the second measurement report includes interference measurements for interference detected based on the OFF pattern, and generates the second notification to include an indication of the interference measurements for interference detected based on the OFF pattern.

Some implementations of the method and apparatuses described herein may include wireless communication at a device (e.g., an RIS control function), and the device receives from a first network node an indication of signal interference associated with a UE; generates first RIS configuration information and transmits, to a second network node associated with an RIS, a first notification including the indication of signal interference and the first RIS configuration information; receives from the first network node an updated indication of signal interference associated with the UE; and generates second RIS configuration information based on the updated indication of signal interference associated with the UE, and transmits, to the second network node, a second notification including the second RIS configuration information

In some implementations of the method and apparatuses described herein, the method is implemented by a central unit associated with a wireless network, and the control function includes an RIS control function implemented at the central unit; generates one or more of the first RIS configuration information or the second RIS configuration information to include a power reduction instruction for the RIS; generates the first RIS configuration information to include an OFF pattern to be applied to the RIS; generates a third notification that identifies the OFF pattern, and transmits the third notification to the first network node for use by the UE in detecting whether signal interference is caused by the RIS.

Some implementations of the method and apparatuses described herein may include wireless communication at a device (e.g., a base station), and the device generates a RIS request that requests access to at least a portion of an RIS, and transmits the RIS request; receives a request response including RIS access configuration information for enabling access to the at least a portion of the RIS; and establishes connectivity with the RIS based at least in part on the RIS access configuration information.

In some implementations of the method and apparatuses described herein, the device generates the RIS request to indicate one or more of a number of instances of user equipment that are associated with the RIS request, or a target service area associated with the RIS request; generates the RIS request to indicate a priority of the RIS request based on one or more of a number of instances of user equipment that are associated with the RIS request, or a target service area associated with the RIS request; receives the request response as an acknowledgement response indicating permission to access the at least a portion of the RIS or a non-acknowledgement response indicating no permission to access the at least a portion of the RIS; transmits the RIS request to an RIS control function at a central unit of a wireless network, and receives the request response from the RIS control function; receives one or more measurement reports indicating signal quality measured at one or more instances of user equipment, and generates and transmits the RIS request based on the one or more measurement reports indicating that the signal quality is below a signal quality threshold; where the RIS access configuration information includes one or more of time slot information for access to the RIS, or time scheduling information for time slots for access to the RIS; where the RIS access configuration information includes an indication of a segment of the RIS that is available, and establishes connectivity with the RIS and utilize the segment of the RIS for connectivity with one or more UEs.

Some implementations of the method and apparatuses described herein may include wireless communication at a device (e.g., a base station), and the device receives an RIS request that requests access to at least a portion of an RIS; generates a request response including RIS access configuration information for enabling access to the at least a portion of the RIS; and transmits the request response.

In some implementations of the method and apparatuses described herein, the RIS request includes one or more of a number of instances of user equipment that are associated with the RIS request, a target service area associated with the RIS request, or a priority of the RIS request; where the apparatus includes a first network node, the RIS request identifies a second network node, and the device transmits a connection notification to the RIS to establish a connection with the second network node; transmits a termination notification to the RIS to terminate a connection to the first network node; generates the connection notification to include connectivity information for connecting the RIS to the second network node; where the RIS request is received from an RIS control function at a central unit of a wireless network, and transmits the request response to the RIS control function at the central unit; where the apparatus includes a first network node associated with the RIS, and the RIS request includes an instruction from the RIS control function for the first network node to cause the RIS to establish connectivity with a second network node; and determines, based on one or more measurement reports from one or more UEs, that the at least a portion of the RIS is allocatable; and generates the request response to indicate that the at least a portion of the RIS is available; determines that the RIS is to be segmented into multiple segments; and transmit a notification to the RIS to segment the RIS into multiple segments and to establish connectivity with multiple network nodes via the multiple segments.

Some implementations of the method and apparatuses described herein may include wireless communication at a device (e.g., a base station), and the device receives from a first network node a first RIS request requesting access to at least a portion of an RIS; generates a second RIS request based at least in part on the first RIS request, and transmits the second RIS request to a second network node associated with the RIS; and receives from the second network node a request response including access configuration information for the first network node to access the RIS.

In some implementations of the method and apparatuses described herein, the device generates a second request response that includes at least some of the access configuration information, and transmits the second request response to the first network node; generates an instruction for the second network node to cause the RIS to establish connectivity with the first network node, and transmits the instruction to the second network node; generates the instruction to indicate that that second network node is to cause the RIS to segment the RIS into two or more segments, and causes the RIS to establish connectivity with the first network node via one or more segments of the two or more segments.

### BRIEF DESCRIPTION OF THE DRAWINGS

Various aspects of the present disclosure for RIS management in wireless systems are described with reference to the following Figures. The same numbers may be used throughout to reference like features and components shown in the Figures.

FIG. 1 illustrates an example of a wireless communications system that supports RIS management in wireless systems in accordance with aspects of the present disclosure.

FIG. 2 illustrates an example of a system that supports RIS management in wireless systems in accordance with aspects of the present disclosure.

FIG. 3 illustrates an example of a system that supports RIS management in wireless systems in accordance with aspects of the present disclosure.

FIG. 4 illustrates an example of a system that supports RIS management in wireless systems in accordance with aspects of the present disclosure.

FIG. 5 illustrates an example of a system that supports RIS management in wireless systems in accordance with aspects of the present disclosure.

FIG. 6 illustrates an example of a system that supports RIS management in wireless systems in accordance with aspects of the present disclosure.

FIG. 7 illustrates an example of a system that supports RIS management in wireless systems in accordance with aspects of the present disclosure.

FIG. 8 illustrates an example of a block diagram of a device that supports RIS management in wireless systems in accordance with aspects of the present disclosure.

FIG. 9 illustrates an example of a block diagram of a device that supports RIS management in wireless systems in accordance with aspects of the present disclosure.

FIG. 10 illustrates an example of a block diagram of a device that supports RIS management in wireless systems in accordance with aspects of the present disclosure.

FIG. 11 illustrates an example of a block diagram of a device that supports RIS management in wireless systems in accordance with aspects of the present disclosure.

FIGS. 12-20 illustrate flowcharts of methods that support RIS management in wireless systems in accordance with aspects of the present disclosure.

### DETAILED DESCRIPTION

The present disclosure relates to methods, apparatuses, and systems that support RIS management in wireless systems. For instance, aspects of the disclosure enable operational aspects of an RIS to be controlled to reduce signal interference caused by operation of the RIS. In an example implementation, a first base station that provides wireless connectivity to a UE determines that the UE is experiencing signal quality degradation that may be caused by operation of an RIS. Accordingly, the first base station communicates with a second base station that controls the RIS to implement a procedure to determine if the RIS is causing signal interference, and if so, modify operation of the RIS to attempt to mitigate the signal interference.

Aspects of the disclosure also enable RIS control to be allocated between different base stations, such as to enable base stations to access an RIS for providing signal communication for UEs served by the base stations. For instance, a first base station determines that UEs connected to the base station are experiencing signal quality problems. Accordingly, the first base station implements a process to obtain access to an RIS to attempt to enhance signal quality for its UEs. As part of this process, for example, the first base station negotiates connectivity to an RIS that is controlled by a second base station. Utilizing the connected RIS, the first base station can enable wireless signal communication between its UEs and the first base station via the connected RIS. Accordingly, by utilizing the described techniques, RIS control can be utilized to reduce signal interference experienced at UEs and to increase UE signal quality.

In some wireless systems, antenna operation can cause signal interference with devices in proximity to an antenna, such as UEs that are at a cell edge and receive wireless service from other antennas and/or service providers. Further, devices near a cell edge may experience signal degradation due to distance form a serving antenna. Accordingly, utilizing the described techniques enables signal interference to be reduced and provides increased signal quality.

Aspects of the present disclosure are described in the context of a wireless communications system. Aspects of the present disclosure are further illustrated and described with reference to device diagrams and flowcharts that relate to RIS management in wireless systems.

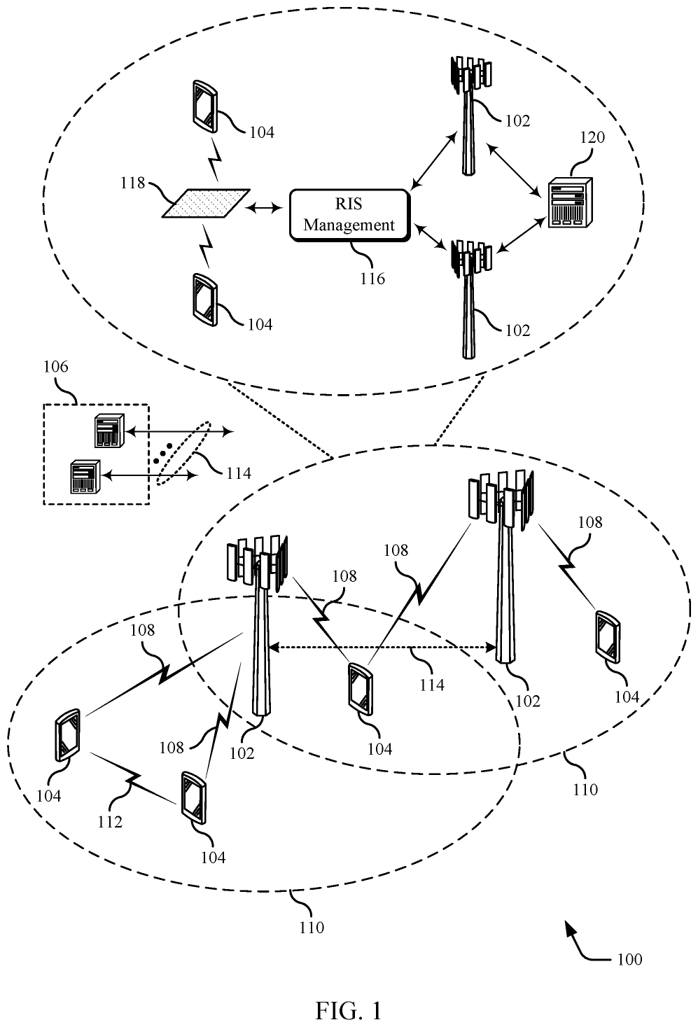

FIG. 1 illustrates an example of a wireless communications system 100 that supports RIS management in wireless systems in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more base stations 102 may interact to perform RIS management 116 of operational aspects of an RIS 118 that support implementations for RIS management in wireless systems. The RIS 118, for instance, provides signal connectivity for different UEs 104 of the wireless communications system 100. Further, a network RIS component 120 can interact with different instances of the base stations 102 to support implementations for RIS management in wireless systems, such as for implementing aspects of the RIS management 116. The network RIS component 120 can be implemented in various ways, such as a component of a core network 106, a functionality implemented at a central unit of a wireless network, and so forth. Different implementations and aspects of the RIS management 116 are detailed throughout this disclosure.

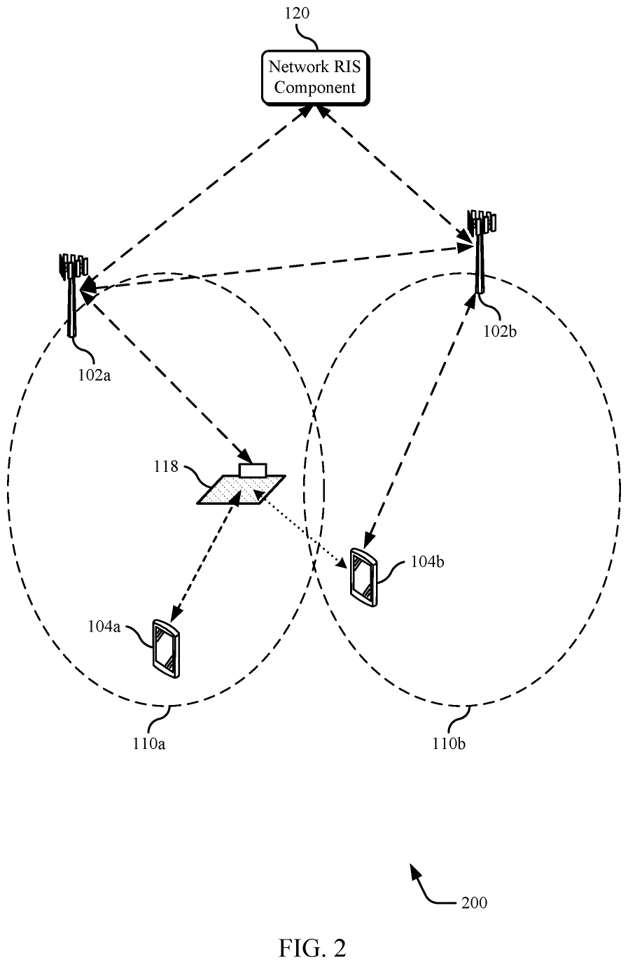

FIG. 2 illustrates an example of a system 200 that supports RIS management in wireless systems in accordance with aspects of the present disclosure. The system 200 may use the wireless communications system 100 and/or be implemented with the wireless communications system. The system 200 includes base stations 102a, 102b, the RIS 118, and UEs 104a, 104b. According to one or more implementations, the RIS 118 can be controlled in various ways such as via the network RIS component 120, locally by the base station 102a (e.g., a gNB and/or transmission reception point (TRP)), or a combination thereof. For instance, control of the RIS 118 can be split into multiple parts: one at the network RIS component 120 which can be responsible for long term configuration of the RIS 118, and/or for coordination of the RIS 118 between different network nodes based on reports from network nodes or their connected UEs. Another control part can be located at the base station 102a (e.g., a network node, e.g., a gNB) which can be responsible for instantaneous and/or short-term configuration of the RIS 118 such as based on reports from the UEs 104, reports from the RIS 118, or combinations thereof.

According to various implementations, the base station 102a utilizes the RIS 118 to provide connectivity of the UE 104a to the base station 102a within a coverage area 110a. Further the base station 102b provides connectivity to the UE 104b within a coverage area 110b. In some scenarios, depending on a position of the UE 104b within the coverage area 110b, the UE 104b can experience signal interference based on operation of the RIS 118. The signal interference, for example, may be due to signal reflection at the RIS 118 affecting downlink (DL) signal propagation of the base station 102b and/or UL signal of the UE 104b, e.g., in deployment scenarios such as dynamic TDD operation.

Accordingly, the base station 102a can control operation of the RIS 118, such as to reduce signal interference from the RIS 118 experienced at the UE 104b. The base station 102a, for instance, can receive direct communication from the base station 102b indicating that the UE 104b is experiencing signal interference that may be a result of operation of the RIS 118. Alternatively or additionally, the base station 102b can communicate an indication of signal interference to the network RIS component 120, and the network RIS component 120 can communicate with the base station 102a to notify the base station 102a that the RIS 118 may be causing signal interference at UEs not served by the base station 102a. Accordingly, and as further detail below, the base station 102a can configure operating parameters of the RIS 118 to enable determination of whether the RIS 118 is causing signal interference experienced at the UE 104b and if so, to reduce the signal interference.

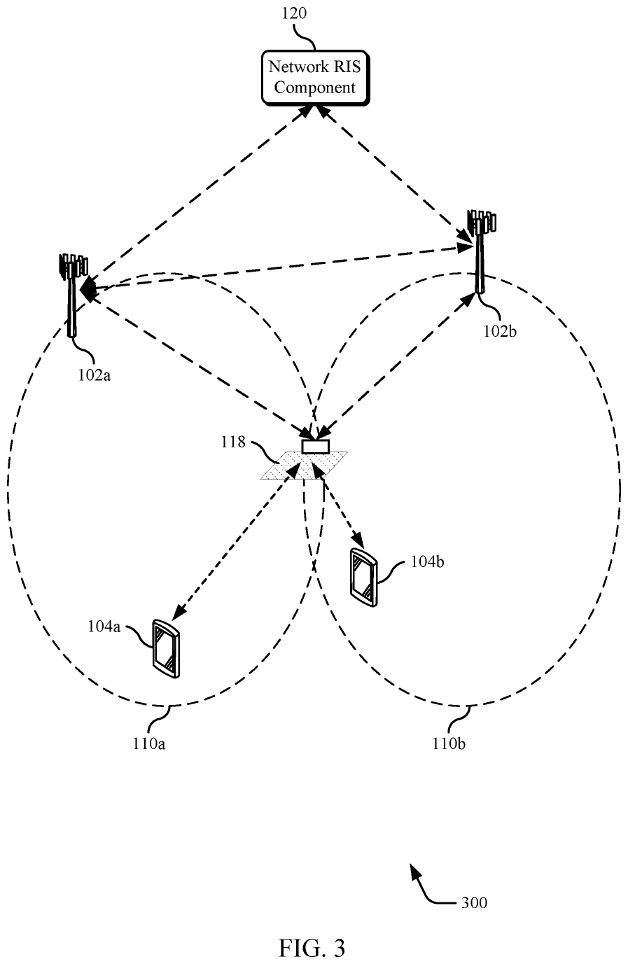

FIG. 3 illustrates an example of a system 300 that supports RIS management in wireless systems in accordance with aspects of the present disclosure. The system 300 may use the wireless communications system 100 and/or be implemented with the wireless communications system. The system 300 includes base stations 102a, 102b, the RIS 118, and UEs 104a, 104b. According to various implementations, one or more portions of the RIS 118 can be controlled by the base station 102a, by the base station 102b, or via a combination of the base stations 102a, 102b. For instance, the base stations 102a, 102b can interact directly to allocate control of the RIS 118. Alternatively or additionally the base stations 102a, 102b can communicate via the network RIS component 120 to allocate control of the RIS 118. In at least one implementation control of the RIS 118 can be switched between the base stations 102a, 102b, such as to transfer control of the RIS 118 from the base station 102a to the base station 102b, and vice-versa. For instance, the base station 102a can utilize the RIS 118 for signal communication with the UE 104a and can then transfer control of the RIS 118 to the base station 102b to enable the base station 102b to utilize the RIS 118 for signal communication with the UE 104b.

Alternatively or additionally control of the RIS 118 can be shared between the base stations 102a, 102b. For instance, the RIS 118 can establish dual connectivity (e.g., simultaneous connectivity) with the base stations 102a, 102b. In at least one implementation, this enables the base station 102a to utilize the RIS 118 for signal communication with the UE 104a concurrently with the base station 102b utilizing the RIS 118 for signal communication with the UE 104b. As detailed below, for instance, the RIS 118 can be segmented into different segments and the base stations 102a, 102b assigned different segments. Alternatively or additionally the base stations 102a, 102b can be assigned different respective time slots and/or signal time scheduling information to enable the base stations 102a, 102b to synchronize concurrent use of the RIS 118.

Wireless systems utilize different types and configurations of antennas and antenna systems for transmitting and receiving wireless signal. However, some antenna systems can have a large impact on the performance of wireless systems. For instance, some antenna designs may cause signal interference with UEs in adjacent coverage areas.

Accordingly, to identify causes of signal interference such as whether an antenna system is causing signal interference, wireless systems utilize different signal measurement techniques. For instance, in the context of channel state information (CSI) resources, each CSI Resource Setting (RS) CSI-ResourceConfig includes a configuration of a list of S≥1 CSI Resource Sets (e.g., given by higher layer parameter csi-RS-ResourceSetList), where the list includes references to either or both of non-zero-power (NZP) CSI-RS resource set(s) and synchronization signal physical broadcast channel (SS/PBCH) block set(s) or the list is comprised of references to CSI-interference measurement (IM) resource set(s). Each CSI Resource Setting is located in the DL bandwidth part (BWP) identified by the higher layer parameter BWP-id, and CSI Resource Settings linked to a CSI Report Setting may have the same DL BWP.

The time domain behavior of CSI-RS resources within a CSI Resource Setting can be indicated by the higher layer parameter resourceType and can be set to aperiodic, periodic, or semi-persistent. For periodic and semi-persistent CSI Resource Settings, the number of CSI-RS Resource Sets configured can be limited to S=1. For periodic and semi-persistent CSI Resource Settings, the configured periodicity and slot offset can be given in the numerology of its associated DL BWP, as given by BWP-id. When a UE is configured with multiple CSI-ResourceConfigs consisting of the same NZP CSI-RS resource ID, a same time domain behavior can be configured for the CSI-ResourceConfigs. When a UE is configured with multiple CSI-ResourceConfigs consisting of the same CSI-IM resource ID, the same time-domain behavior can be configured for the CSI-ResourceConfigs. Further, CSI Resource Settings linked to a CSI Report Setting can have the same time domain behavior.

In at least one implementation, the following are configured via higher layer signaling for one or more CSI Resource Settings for channel and interference measurement:
CSI-IM resource for interference measurement
NZP CSI-RS resource for interference measurement
NZP CSI-RS resource for channel measurement

In at least one implementation, a UE may assume that the NZP CSI-RS resource(s) for channel measurement and the CSI-IM resource(s) for interference measurement configured for one CSI reporting are resource-wise quasi-co-located (QCLed) with respect to ‘typeD’. When NZP CSI-RS resource(s) are used for interference measurement, a UE may assume that the NZP CSI-RS resource for channel measurement and the CSI-IM resource or NZP CSI-RS resource(s) for interference measurement configured for one CSI reporting are QCLed with respect to ‘typeD’.

For L1-signal to noise plus interference ratio (SINR) measurement:
When one Resource Setting is configured, the Resource Setting (given by higher layer parameter resourcesForChannelMeasurement) is for channel and interference measurement on NZP CSI-RS for L1-SINR computation. A UE may assume that same 1 port NZP CSI-RS resource(s) with density 3 resource elements/resource blocks (REs/RBs) can be used for both channel and interference measurements.
When two Resource Settings are configured, the first one Resource Setting (given by higher layer parameter resourcesForChannelMeasurement) is for channel measurement on SSB or NZP CSI-RS and the second one (given by either higher layer parameter csi-IM-ResourcesForInterference or higher layer parameter nzp-CSI-RS-ResourcesForInterference) is for interference measurement performed on CSI-IM or on 1 port NZP CSI-RS with density 3 REs/RB, where each synchronization signal block (SSB) or NZP CSI-RS resource for channel measurement is associated with one CSI-IM resource or one NZP CSI-RS resource for interference measurement by the ordering of the SSB or NZP CSI-RS resource for channel measurement and CSI-IM resource or NZP CSI-RS resource for interference measurement in the corresponding resource sets. The number of SSB(s) or CSI-RS resources for channel measurement equals to the number of CSI-IM resources or the number of NZP CSI-RS resource for interference measurement.
   A UE may apply the SSB, or ‘typeD’ RS configured with qcl-Type set to ‘typeD’ to the NZP CSI-RS resource for channel measurement, as the reference RS for determining ‘typeD’ assumption for the corresponding CSI-IM resource or the corresponding NZP CSI-RS resource for interference measurement configured for one CSI reporting.
   A UE may expect that the NZP CSI-RS resource set for channel measurement and the NZP-CSI-RS resource set for interference measurement, if any, are configured with the higher layer parameter repetition.

For aperiodic CSI, each trigger state configured using the higher layer parameter CSI-AperiodicTriggerState can be associated with one or multiple CSI-ReportConfig where each CSI-ReportConfig is linked to periodic, or semi-persistent, or aperiodic resource setting(s):
When one Resource Setting is configured, the Resource Setting (given by higher layer parameter resourcesForChannelMeasurement) can be for channel measurement for L1-RSRP or for channel and interference measurement for L1-SINR computation.
When two Resource Settings are configured, the first one Resource Setting (given by higher layer parameter resourcesForChannelMeasurement) can be for channel measurement and the second one (given by either higher layer parameter csi-IM-ResourcesForInterference or higher layer parameter nzp-CSI-RS-ResourcesForInterference) can be for interference measurement performed on CSI-IM or on NZP CSI-RS.
When three Resource Settings are configured, the first Resource Setting (higher layer parameter resourcesForChannelMeasurement) can be for channel measurement, the second one (given by higher layer parameter csi-IM-ResourcesForInterference) can be for CSI-IM based interference measurement and the third one (given by higher layer parameter nzp-CSI-RS-ResourcesForInterference) can be for NZP CSI-RS based interference measurement.

For semi-persistent or periodic CSI, each CSI-ReportConfig is linked to periodic or semi-persistent Resource Setting(s):
When one Resource Setting (given by higher layer parameter resourcesForChannelMeasurement) is configured, the Resource Setting can be for channel measurement for L1-RSRP or for channel and interference measurement for L1-SINR computation.
When two Resource Settings are configured, the first Resource Setting (given by higher layer parameter resourcesForChannelMeasurement) can be for channel measurement and the second Resource Setting (given by higher layer parameter csi-IM-ResourcesForInterference) can be used for interference measurement performed on CSI-IM. For L1-SINR computation, the second Resource Setting (given by higher layer parameter csi-IM-ResourcesForInterference or higher layer parameter nzp-CSI-RS-ResourceForInterference) can be used for interference measurement performed on CSI-IM or on NZP CSI-RS.

In at least some implementations, a UE is not expected to be configured with more than one CSI-RS resource in resource set for channel measurement for a CSI-ReportConfig with the higher layer parameter codebookType set to either ‘typeII’, ‘typeII-PortSelection’, ‘typeII-r16’ or to ‘typeII-PortSelection-r16’. A UE is not expected to be configured with more than 64 NZP CSI-RS resources and/or SS/PBCH block resources in resource setting for channel measurement for a CSI-ReportConfig with the higher layer parameter reportQuantity set to ‘none’, ‘cri-RI-CQI’, ‘cri-RSRP’, ‘ssb-Index-RSRP’, ‘cri-SINR’ or ‘ssb-Index-SINR’. If interference measurement is performed on CSI-IM, each CSI-RS resource for channel measurement can be resource-wise associated with a CSI-IM resource by the ordering of the CSI-RS resource and CSI-IM resource in the corresponding resource sets. The number of CSI-RS resources for channel measurement can be equal to the number of CSI-IM resources.

In at least some implementations, except for L1-SINR, if interference measurement is performed on NZP CSI-RS, a UE does not expect to be configured with more than one NZP CSI-RS resource in the associated resource set within the resource setting for channel measurement. In at least some implementations, except for L1-SINR, the UE configured with the higher layer parameter nzp-CSI-RS-ResourcesForInterference may expect no more than 18 NZP CSI-RS ports configured in a NZP CSI-RS resource set.

For CSI measurement(s) other than L1-SINR, a UE can assume:
each NZP CSI-RS port configured for interference measurement corresponds to an interference transmission layer.
interference transmission layers on NZP CSI-RS ports for interference measurement take into account associated EPRE ratios;
other interference signal on REs of NZP CSI-RS resource for channel measurement, NZP CSI-RS resource for interference measurement, or CSI-IM resource for interference measurement.

For L1-SINR measurement with dedicated interference measurement resources, a UE can assume that the total received power on dedicated NZP CSI-RS resource for interference measurement or dedicated CSI-IM resource for interference measurement corresponds to interference and noise.

Aspects of the disclosure enable operational aspects of an RIS to be controlled to reduce signal interference caused by operation of the RIS. In an example implementation, a first base station that provides wireless connectivity to a UE determines that the UE is experiencing signal quality degradation that may be caused by operation of an RIS. Accordingly, the first base station communicates with a second base station that controls the RIS to implement a procedure to determine if the RIS is causing signal interference, and if so, modify operation of the RIS to attempt to mitigate the signal interference.

Aspects of the disclosure also enable RIS control to be allocated between different base stations, such as to enable base stations to access an RIS for providing signal communication for UEs served by the base stations. For instance, a first base station determines that UEs connected to the base station are experiencing signal quality problems. Accordingly, the first base station implements a process to obtain access to an RIS to attempt to enhance signal quality for its UEs. As part of this process, for example, the first base station negotiates connectivity to an RIS that is controlled by a second base station. Utilizing the connected RIS, the first base station can enable wireless signal communication between its UEs and the first base station via the connected RIS. Accordingly, by utilizing the described techniques, RIS control can be utilized to reduce signal interference experienced at UEs and to increase UE signal quality.

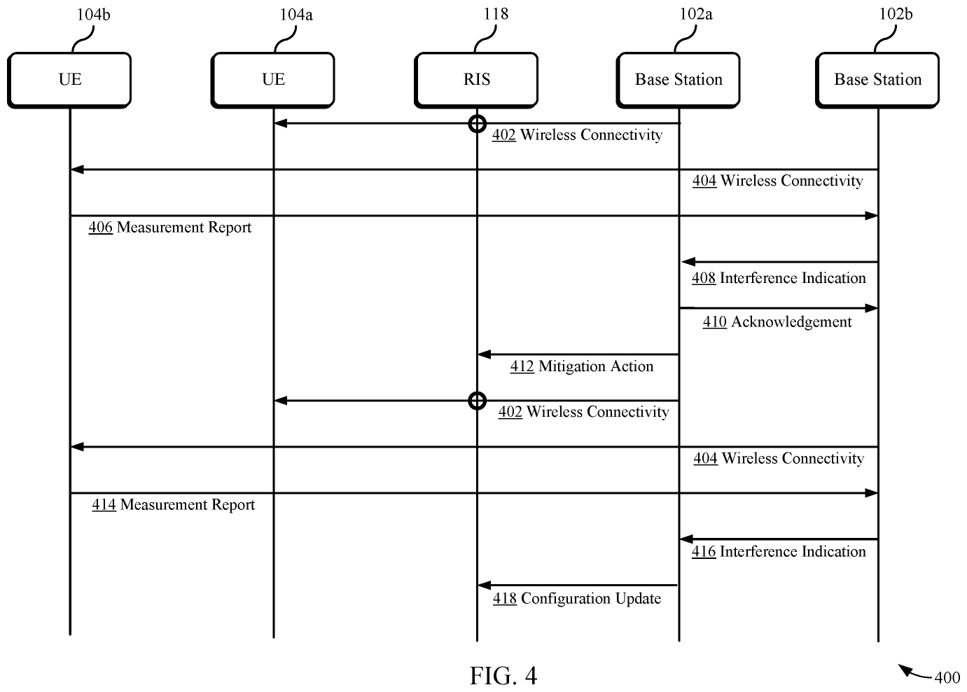

FIG. 4 illustrates an example of a system 400 that supports RIS management in wireless systems in accordance with aspects of the present disclosure. The system 400 may use the wireless communications system 100 and/or be implemented with the wireless communications system. In the system 400 at 402 the base station 102a utilizes the RIS 118 for wireless connectivity to the UE 104a, such as for providing wireless conductivity of DL signal from the base station 102a reflected via the RIS 118 to the UE 104a. Further, at 404 the base station 102b provides wireless connectivity to the UE 104b.

Further to the system 400, at 406 the UE 104b provides a measurement report to the base station 102b indicating signal quality detected at the UE 104b, such as for UL and DL signal communicated between the UE 104b and the base station 102b. In at least one implementation the measurement report indicates a measured CSI-IM and a level of interference. Based on the measurement report the base station 102b can determine that the interference reaches a predefined interference threshold. In another implementation the base station 102b can detect a link failure of the UE 104b, such as when the UE 104b is located close to a cell edge, e.g., close to the RIS 118 controlled by the base station 102a.

Accordingly, at 408 the base station 102b communicates an interference indication to the base station 102a based at least in part on the received measurement report. In at least one implementation the interference indication identifies interference that is caused by the RIS 118 and experienced at the UE 104b, such as due to signal reflection from the RIS 118. The indicated interference can include various types of interference, such as cross time slot interference, e.g., under dynamic time division duplex (TDD) operation. In at least one implementation the base station 102b sends the interference indication directly to the base station 102a, such as via a connection between CUs in a scenario where the network nodes belong to different CUs. In one example, the interference indication includes information about a level of the interference and a value for reduction of the power to be applied to the RIS 118 to reduce signal interference at the UE 104b. Alternatively or additionally the interference indication identifies an affected coverage area, such as based on UE reports from a certain coverage area.

Further to the system 400, the base station 102a receives the interference indication and at 410 communicates an acknowledgement to the base station 102b of the interference indication. Further, at 412 the base station 102a performs a mitigation action or set of mitigation actions to attempt to reduce interference caused by the RIS 118. For instance, the base station 102a reduces transmitted power towards its UEs close to an identified area by configuring the RIS 118 with coefficients (e.g., reflection coefficients) such that signal coverage of the RIS 118 is reduced. In an additional or alternative implementation, the base station 102a applies beam refinement via the RIS 118 and/or optimizes the RIS coefficients for its UEs close to the affected area, such as to avoid and/or reduce the transmission power in the direction of the affected area to minimize the interference with the UE 104b and UEs in proximity to the UE 104b.

In an additional or alternative implementation, to identify a direction and/or the level of interference experienced at the UE 104b, the base station 102b sends along with the interference indication a suggested configuration for OFF pattern or power reduction pattern for specific time slots, e.g., on some CSI-IM time slots and/or symbols of the UE 104b. The base station 102a can apply the suggested OFF pattern and/or power reduction pattern to the RIS 118 such that the RIS 118 is switched OFF according to the specified OFF pattern and/or power reduction pattern, e.g., by applying coefficients to perform signal absorption instead of reflection on the specified time slots. Based on the applied OFF pattern and/or power reduction pattern, the UE 104b connected to the base station 102b can identify a level of signal interference and/or the angle of arrival (AoA) of interfered signal. In an alternative or additional implementation, the base station 102a replies to the base station 102b (e.g., in conjunction with the acknowledgement) with a different OFF pattern configuration that the base station 102a will apply to the RIS 118. This enables the base station 102b to monitor indications of signal interference from the UE 104b for correlation to the different OFF pattern configuration and determine an amount of signal interference at the UE 104b caused by the RIS 118.

In an additional or alternative implementation, the base station 102a sends to the base station 102b an indication of time slots when the RIS 118 is switched OFF. The base station 102b can communicate to the UE 104b with the OFF pattern of the RIS 118 and/or with an agreed OFF pattern, e.g., on the configured CSI-IM for interference measurement. At 414 the UE 104b communicates a measurement report to the base station 102b, such as to report measurements for both cases, e.g., when OFF pattern indicates that the RIS is OFF and when the RIS is ON. In at least one implementation, the UE 104b applies averaging over CSI-IM symbols for each case separately and reports the averaged measurements via two measurement reports.

Accordingly, based on the measurement report 414, at 416 the base station 102b communicates an updated interference indication to the base station 102a. In at least one implementation the updated interference indication includes interference measurements from the measurement report and/or suggested settings (e.g., OFF settings, power settings, etc.) for the RIS 118. The base station 102a receives the updated interference indication and at 418 performs a configuration update on the RIS 118, such as to apply a recommended OFF pattern and/or recommended power reduction pattern to the RIS 118.

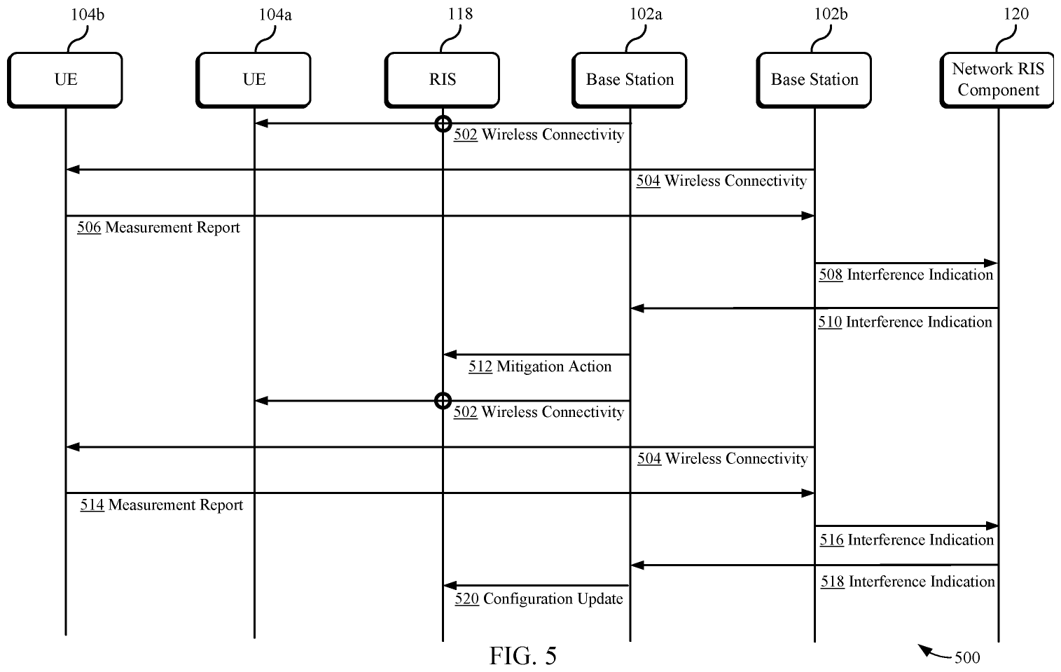

FIG. 5 illustrates an example of a system 500 that supports RIS management in wireless systems in accordance with aspects of the present disclosure. The system 500 may use the wireless communications system 100 and/or be implemented with the wireless communications system. The system 500, for example, represents an alternative or addition to the system 400. In the system 400 at 502 the base station 102a utilizes the RIS 118 for wireless connectivity to the UE 104a, such as for providing wireless conductivity of DL signal from the base station 102a reflected via the RIS 118 to the UE 104a. Further, at 504 the base station 102b provides wireless connectivity to the UE 104b. The network RIS component 120 is also depicted and is operable to communicate with the base stations 102a, 102b. In at least one implementation the network RIS component 120 is implemented to control at least some operational aspects of the base stations 102a, 102b and/or the RIS 118. As an exemplary example, the network RIS component 120 can be implemented at a CU, such as when both of the base stations 102a, 102b are connected to a same CU. In an alternative or additional implementation, the network RIS component 120 can be implemented as a component of a core network.

Further to the system 500, at 506 the UE 104b provides a measurement report to the base station 102b indicating signal quality detected at the UE 104b, such as for UL and DL signal communicated between the UE 104b and the base station 102b. In at least one implementation the measurement report indicates a measured CSI-IM and a level of interference. Based on the measurement report the base station 102b can determine that the interference reaches a predefined interference threshold. In another implementation the base station 102b can detect a link failure of the UE 104b, such as when the UE 104b is located close to a cell edge, e.g., close to the RIS 118 controlled by the base station 102a.

Accordingly, at 508 the base station 102b communicates a first interference indication to the network RIS component 120 based at least in part on the received measurement report. In at least one implementation the first interference indication identifies interference that is caused by the RIS 118 and experienced at the UE 104b, such as due to signal reflection from the RIS 118. The indicated interference can include various types of interference, such as cross time slot interference, e.g., under dynamic time division duplex (TDD) operation. Alternatively or additionally the first interference indication identifies an affected coverage area, such as based on UE reports from a certain coverage area.

Based on the first interference indication, at 510 the network RIS component 120 communicates a second interference indication to the base station 102a. In one example, the second interference indication includes information about a level of the interference and a value for reduction of the power to be applied to the RIS 118 to reduce signal interference at the UE 104b.

Further to the system 500, the base station 102a receives the second interference indication and at 512 the base station 102a performs a mitigation action or set of mitigation actions to attempt to reduce interference caused by the RIS 118. For instance, the base station 102a reduces transmitted power towards its UEs close to an identified coverage area by configuring the RIS 118 with coefficients (e.g., reflection coefficients) such that signal coverage of the RIS 118 is reduced. In an additional or alternative implementation, the base station 102a applies beam refinement via the RIS 118 and/or optimizes the RIS coefficients for its UEs close to the affected area, such as to avoid and/or reduce the transmission power in the direction of the affected area to minimize the interference with the UE 104b and UEs in proximity to the UE 104b.

In an additional or alternative implementation, to identify a direction and/or the level of interference experienced at the UE 104b, the network RIS component 120 sends along with the second interference indication a suggested configuration for OFF pattern or power reduction pattern for specific time slots, e.g., on some CSI-IM time slots and/or symbols of the UE 104b. The base station 102a can apply the suggested OFF pattern and/or power reduction pattern to the RIS 118 such that the RIS 118 is switched OFF according to the specified OFF pattern and/or power reduction pattern, e.g., by applying coefficients to perform signal absorption instead of reflection on the specified time slots. Based on the applied OFF pattern and/or power reduction pattern, the UE 104b connected to the base station 102b can identify a level of signal interference and/or the AoA of interfered signal. In an alternative or additional implementation, the base station 102a replies to the base station 102b (e.g., in conjunction with the acknowledgement) with a different OFF pattern configuration that the base station 102a will apply to the RIS 118. This enables the base station 102b to monitor indications of signal interference from the UE 104b for correlation to the different OFF pattern configuration and determine an amount of signal interference at the UE 104b caused by the RIS 118.

In an additional or alternative implementation, the base station 102a sends to the network RIS component 120 an indication of time slots when the RIS 118 is switched OFF, and the network RIS component 120 sends this indication to the base station 102b. The base station 102b can communicate to the UE 104b with the OFF pattern of the RIS 118 and/or with an agreed OFF pattern, e.g., on the configured CSI-IM for interference measurement.

At 514 the UE 104b communicates an updated measurement report to the base station 102b, such as to report measurements for both cases, e.g., when OFF pattern indicates that the RIS is OFF and when the RIS is ON. In at least one implementation, the UE 104b applies averaging over CSI-IM symbols for each case separately and reports the averaged measurements via two measurement reports.

Accordingly, based on the measurement report 514, at 516 the base station 102b communicates a third interference indication to the network RIS component 120 and at 518 the network RIS component communicates a fourth interference indication to the base station 102a. In at least one implementation the third interference indication and/or fourth interference indication include interference measurements from the updated measurement report and/or suggested settings (e.g., OFF settings, power settings, etc.) for the RIS 118. The base station 102a receives the fourth interference indication and at 520 performs a configuration update on the RIS 118, such as to apply a recommended OFF pattern and/or recommended power reduction pattern to the RIS 118.

In an alternative or additional implementation, the network RIS component 120 sends RIS-specific RS configuration to the base station 102a with spatial information for the RIS 118 towards affected UEs (e.g., the UE 104b) of the base station 102b. The UE 104b may report a level of the interference (e.g., RSRP of the configured RS) and may also report the direction of arrival of the reflected signal from the RIS 118.

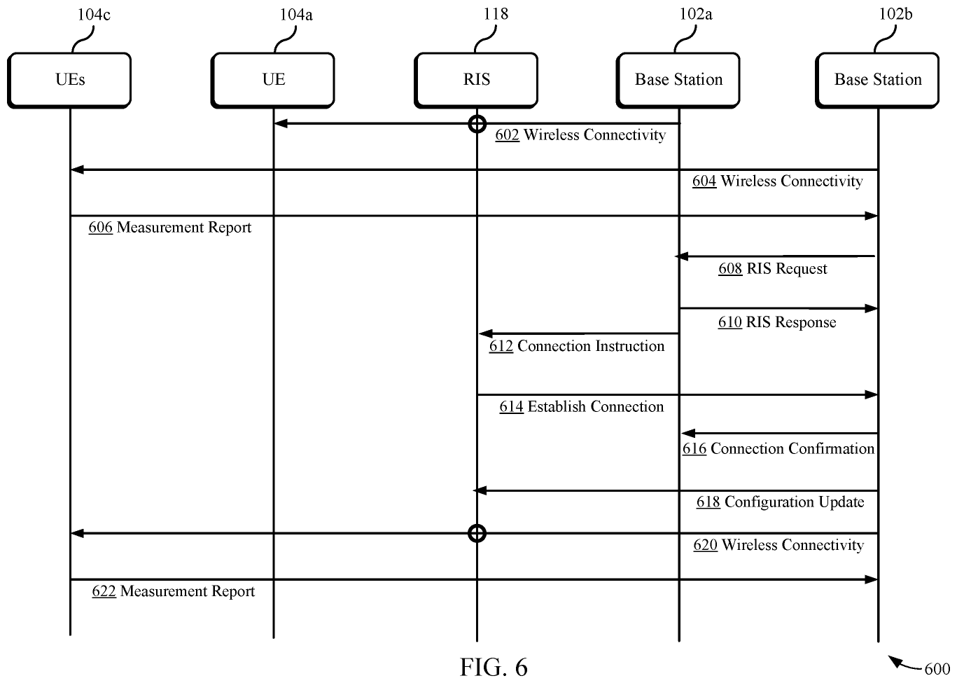

FIG. 6 illustrates an example of a system 600 that supports RIS management in wireless systems in accordance with aspects of the present disclosure. The system 600 may use the wireless communications system 100 and/or be implemented with the wireless communications system. In the system 600 at 602 the base station 102a utilizes the RIS 118 for wireless connectivity to the UE 104a, such as for providing wireless conductivity of DL signal from the base station 102a reflected via the RIS 118 to the UE 104a. Further, at 604 the base station 102b provides wireless connectivity to UEs 104c. The UEs 104c, for instance, represent a group of UEs 104 for which the base station 102b provides wireless connectivity.

Further to the system 600, at 606 the UEs 104c communicate measurement reports indicating signal attributes (e.g., signal quality) experienced at the UEs 104c to the base station 102b. In at least one implementation the measurement reports indicate low signal quality experienced at the UEs 104c. The UEs 104c, for example, represent UEs positioned at a cell edge for the base station 102b. Accordingly, the base station 102b determines to request RIS support. The base station 102b, for instance, determines that RIS support can increase signal quality for the UEs 104c. Further, the base station 102b determines parameters for an RIS request, such as a number of the UEs 104c that may benefit from coverage enhancement, a service type of the UEs 104c, e.g., enhanced mobile broadband (eMBB), ultra-reliable low latency communications (URLLC), etc.

Accordingly, at 608 the base station 102b sends an RIS request to the base station 102a, such as directly via an inter-node interface. The RIS request, for instance, requests that the base station 102a enable the base station 102b to at least partially control the RIS 118. For example, when the measurement reports from the UEs 104c indicate a drop in link quality below a predefined threshold, the base station 102b triggers the RIS request to the base station 102a that controls the RIS 118.

In at least one implementation, the RIS request includes an indication for handover of RIS control. Alternatively or additionally, the RIS request includes information about a number of the UEs 104c to be provided with RIS support and/or a service type of the UEs 104c. In yet another alternative or additional implementation, the RIS request includes priority information that indicates a level of importance of the RIS support, such as based on a number of the UEs 104c to be provided with RIS support and/or a service type of the UEs 104c.

Further to the system 600, at 610 the base station 102a communicates an RIS response to the base station 102b. The RIS response may include an acknowledgement for switching at least some RIS control to the base station 102b, or a non-acknowledgment for RIS control by the base station 102b. For instance, the base station 102a determines based on on-going operation of the RIS 118 and a number of UEs connected via the RIS 118 to the base station 102a and/or their service type that control of the RIS 118 is not to be handed over to the base station 102b.

In at least one implementation, the RIS response may include time slots for which control of the RIS 118 can be handed to the base station 102b. In an additional or alternative implementation, the base station 102a may indicate sharing the control of the RIS 118 based on time scheduling such that each base station 102a, 102b controls the RIS 118 for predefined time slots. In yet another additional or alternative implementation, the RIS response indicates that the surface of the RIS 118 is to be split into two or more segments such that each base station 102a, 102b controls a different respective segment of the surface. In such a scenario an RIS controller at the RIS 118 can establish dual connectivity to both of the base stations 102a, 102b simultaneously.

Further to the system 600 (e.g., upon an agreed decision between the base stations 102a, 102b to share or switch RIS control), at 612 the base station 102a communicates a connection instruction to the RIS 118. The connection instruction, for example, includes connection configuration information for connecting the RIS 118 to the base station 102b. Examples of connection configuration information include an instruction for the RIS 118 to terminate its connection to the base station 102a and establish a connection to the base station 102b, segment a surface of the RIS 118 and establish dual connections to the base station 102a and the base station 102b, share RIS control between the base stations 102a, 102b such as based on indicated time slots, and so forth.

In at least one implementation, if the RIS 118 is already synchronized and/or connected to both of the base stations 102a, 102b, but controlled only by the base station 102a, the connection instruction from the base station 102a can include an indication for switching RIS control to the base station 102b.

In at least one implementation, based on the connection instruction, at 614 the RIS 118 establishes connectivity to the base station 102b. For instance, upon receiving the connection instruction from the base station 102a, the RIS 118 sends an indication to the base station 102b for switching RIS control to the base station 102b. For example, if the RIS 118 is not connected to the base station 102b, the connection instruction can include connectivity information for connecting the RIS 118 to the base station 102b, such as cell ID of the base station 102b and/or other information for connectivity between the RIS and the base station 102b, thus, the RIS 118 can start initial access procedure to the base station 102b and complete the connection to enable the base station 102b to at least partially control the RIS 118.

Further to the system 600, after connectivity is established between the base station 102b and the RIS 118, at 616 the base station 102b communicates a connection confirmation to the base station 102a indicating that the base station 102b successfully connected to the RIS 118. Further, at 618 the base station 102b performs a configuration update to configure communication parameters for connectivity between the base station 102b and the RIS 118 and at 620 the base station 102b utilizes the RIS 118 for wireless connectivity to the UEs 104c, such as for providing wireless conductivity of DL signal from the base station 102b reflected via the RIS 118 to the UEs 104c. The configuration update at 618, for instance, configures the RIS 118 and/or an identified RIS segment with time slot information and/or spatial information for signal communication to the UEs 104c, such as configured to enhance signal coverage of the UEs 104c.

After the base station 102b assumes at least partial control of the RIS 118, at 622 the UEs 104c communicate updated measurement reports to the base station 102b. The updated measurement reports, for instance, include updated signal attributes such as signal quality and/or signal strength. Thus, the base station 102b can determine based on the updated measurement reports whether connectivity to the RIS 118 provides enhanced signal coverage for the UEs 104c, e.g., an increase in signal quality and/or signal strength.

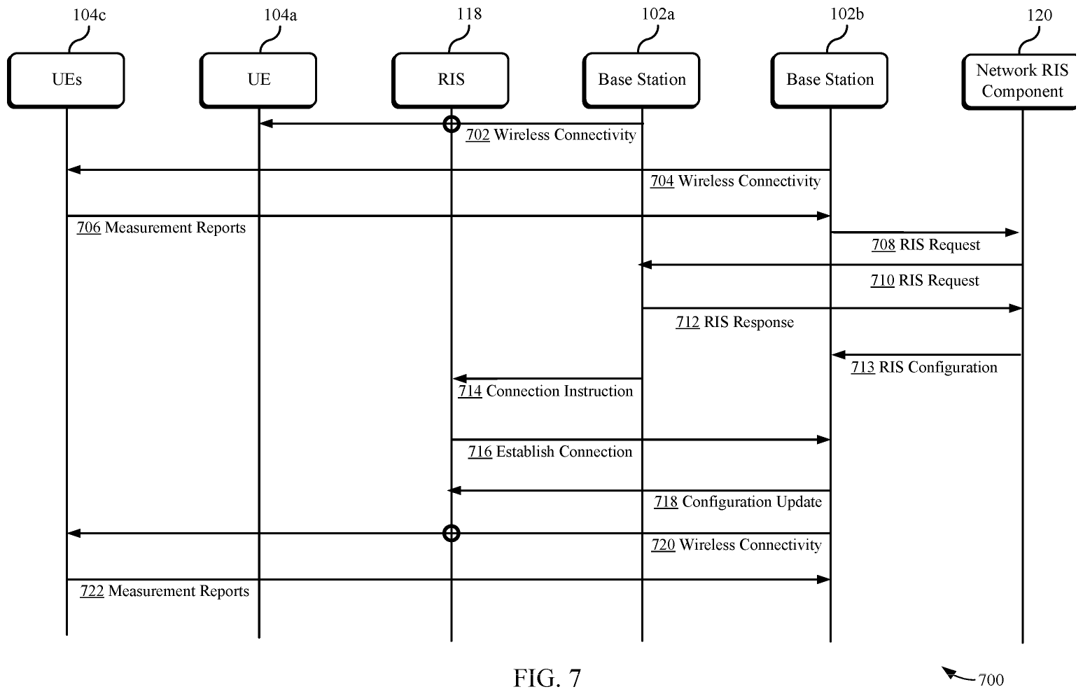

FIG. 7 illustrates an example of a system 700 that supports RIS management in wireless systems in accordance with aspects of the present disclosure. The system 700 may use the wireless communications system 100 and/or be implemented with the wireless communications system. In the system 700 at 702 the base station 102a utilizes the RIS 118 for wireless connectivity to the UE 104a, such as for providing wireless conductivity of DL signal from the base station 102a reflected via the RIS 118 to the UE 104a. Further, at 704 the base station 102b provides wireless connectivity to UEs 104c. The UEs 104c, for instance, represent a group of UEs 104 for which the base station 102b provides wireless connectivity. The network RIS component 120 is also depicted and is operable to communicate with the base stations 102a, 102b. The network RIS component 120, for instance, can enable control of the RIS 118 to be switched between the base stations 102a, 102b.

Further to the system 700, at 706 the UEs 104c communicate measurement reports indicating signal attributes (e.g., signal quality) experienced at the UEs 104c to the base station 102b. In at least one implementation the measurement reports indicate low signal quality experienced at the UEs 104c. The UEs 104c, for example, represent UEs positioned at a cell edge for the base station 102b. Accordingly, the base station 102b determines to request RIS support. The base station 102b, for instance, determines that RIS support can increase signal quality for the UEs 104c. Further, the base station 102b determines parameters for an RIS request, such as a number of the UEs 104c that may benefit from coverage enhancement, a service type of the UEs 104c, e.g., enhanced mobile broadband (eMBB), ultra-reliable low latency communications (URLLC), etc.

Accordingly, at 708 the base station 102b sends a first RIS request to the network RIS component 120. The first RIS request, for instance, requests that the network RIS component 120 enable the base station 102b to at least partially control the RIS 118. For example, when the measurement reports from the UEs 104c indicate a drop in link quality below a predefined threshold, the base station 102b triggers the first RIS request to the network RIS component 120.

In at least one implementation, the first RIS request includes an indication for handover of RIS control. Alternatively or additionally, the first RIS request includes information about a number of the UEs 104c to be provided with RIS support and/or a service type of the UEs 104c. In yet another alternative or additional implementation, the first RIS request includes priority information that indicates a level of importance of the RIS support, such as based on a number of the UEs 104c to be provided with RIS support and/or a service type of the UEs 104c.

Further to the system 700, at 710 the network RIS component 120 sends a second RIS request to the base station 102a requesting that the base station 102a transfer at least partial control of the RIS 118 to the base station 102b. The second RIS request, for instance, includes at least some information from the first RIS request communicated by the base station 102b.

At 712 the base station 102a communicates an RIS response to the network RIS component 120. The RIS response may include an acknowledgement for switching at least some RIS control to the base station 102b, or a non-acknowledgment for RIS control by the base station 102b. For instance, the base station 102a determines based on on-going operation of the RIS 118 and a number of UEs connected via the RIS 118 to the base station 102a and/or their service type that control of the RIS 118 is not to be handed over to the base station 102b.

In at least one implementation, the RIS response may include time slots for which control of the RIS 118 can be handed to the base station 102b. In an additional or alternative implementation, the base station 102a may indicate sharing the control of the RIS 118 based on time scheduling such that each base station 102a, 102b controls the RIS 118 for predefined time slots. In yet another additional or alternative implementation, the RIS response indicates that the surface of the RIS 118 is to be split into two or more segments such that each base station 102a, 102b controls a different respective segment of the surface. In such a scenario an RIS controller at the RIS 118 can establish dual connectivity to both of the base stations 102a, 102b simultaneously.

Upon receiving the RIS response from the base station 102a, at 713 the network RIS component 120 sends RIS configuration to the base station 102b. In one implementation, the RIS configuration contains acknowledgement for handling the RIS control. In another implementation the RIS configuration contains information for time slots at which the base station 102b can control the RIS 118 and use it for its UEs 104c.

In yet another implementation, the network RIS component 120 informs both base stations 102a, 102b to split the RIS surface into two or more segments such that each base station controls part of the surface. In such a case, the RIS 118 can establish dual connectivity to both base stations 102a, 102b simultaneously.

In at least one implementation, upon an agreed decision to share or switch control of the RIS 118, the base station 102a receives a command from the network RIS component 120 to configure the RIS 118 to do one of the following-terminate the connection between the RIS 118 and the base station 102a and establish a connection between the RIS 118 and the base station 102b, segment the surface of the RIS 118 and establish dual connection to the base station 102b, switch the control between both base stations 102a, 102b based on the indicated time slots, etc.

Further to the system 700 (e.g., upon an agreed decision between the base stations 102a, 102b to share or switch RIS control), at 714 the base station 102a communicates a connection instruction to the RIS 118. The connection instruction, for example, includes connection configuration information for connecting the RIS 118 to the base station 102b. Examples of connection configuration information include an instruction for the RIS 118 to terminate its connection to the base station 102a and establish a connection to the base station 102b, segment a surface of the RIS 118 and establish dual connections to the base station 102a and the base station 102b, share RIS control between the base stations 102a, 102b such as based on indicated time slots, and so forth.

In at least one implementation, if the RIS 118 is already synchronized and/or connected to both of the base stations 102a, 102b, but controlled only by the base station 102a, the connection instruction from the base station 102a can include an indication for switching RIS control to the base station 102b.

In at least one implementation, based on the connection instruction, at 716 the RIS 118 establishes connectivity to the base station 102b. For instance, upon receiving the connection instruction from the base station 102a, the RIS 118 sends an indication to the base station 102b for switching RIS control to the base station 102b. For example, if the RIS 118 is not connected to the base station 102b, the connection instruction can include connectivity information for connecting the RIS 118 to the base station 102b, such as cell ID of the base station 102b and/or other information for connectivity between the RIS and the base station 102b, thus, the RIS 118 can start initial access procedure to the base station 102b and complete the connection to enable the base station 102b to at least partially control the RIS 118.

Further to the system 700, after connectivity is established between the base station 102b and the RIS 118, at 718 the base station 102b performs a configuration update to configure communication parameters for connectivity between the base station 102b and the RIS 118 and at 720 the base station 102b utilizes the RIS 118 for wireless connectivity to the UEs 104c, such as for providing wireless conductivity of DL signal from the base station 102b reflected via the RIS 118 to the UEs 104c. The configuration update, for instance, configures the RIS 118 and/or an identified RIS segment with time slot information and/or spatial information for signal communication to the UEs 104c, such as configured to enhance signal coverage of the UEs 104c.

After the base station 102b assumes at least partial control of the RIS 118, at 722 the UEs 104c communicate updated measurement reports to the base station 102b. The updated measurement reports, for instance, include updated signal attributes such as signal quality and/or signal strength. Thus, the base station 102b can determine based on the updated measurement reports whether connectivity to the RIS 118 provides enhanced signal coverage for the UEs 104c, e.g., an increase in signal quality and/or signal strength

In an alternative or additional implementation, based on the updated measurement reports, the based station 102b determines that the RIS 118 is not required for extending the coverage for its UEs 104c and sends message to the network RIS component 120 indicating that control of the RIS 118 is released or can be released.

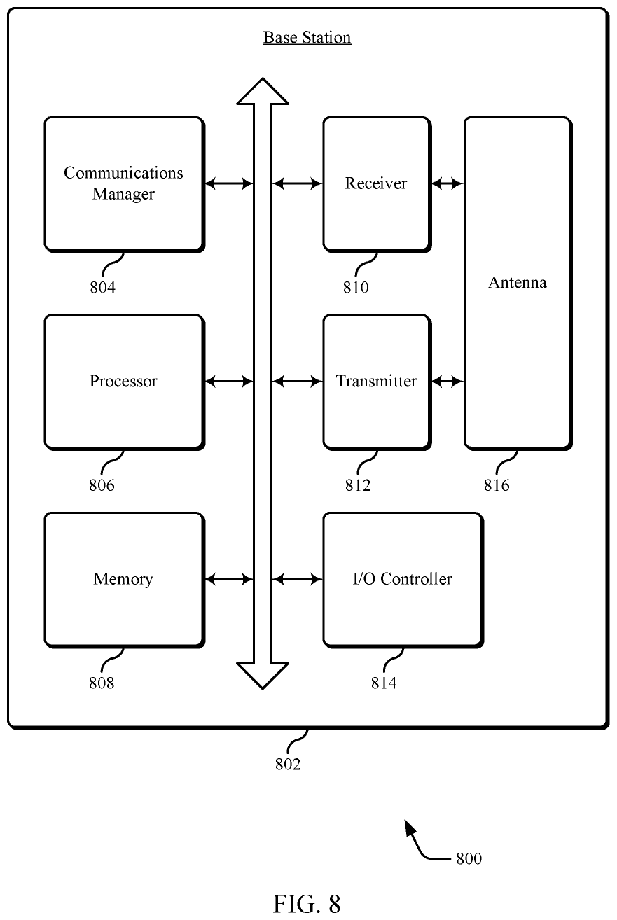

FIG. 8 illustrates an example of a block diagram 800 of a device 802 that supports RIS management in wireless systems in accordance with aspects of the present disclosure. The device 802 may be an example of a base station 102, such as a gNB as described herein. The device 802 may support wireless communication and/or network signaling with one or more base stations 102, other UEs 104, core network devices and functions (e.g., core network 106), or any combination thereof. The device 802 may include components for bi-directional communications including components for transmitting and receiving communications, such as a communications manager 804, a processor 806, a memory 808, a receiver 810, a transmitter 812, and an I/O controller 814. These components may be in electronic communication or otherwise coupled (e.g., operatively, communicatively, functionally, electronically, electrically) via one or more interfaces (e.g., buses).

The communications manager 804, the receiver 810, the transmitter 812, or various combinations thereof or various components thereof may be examples of means for performing various aspects of the present disclosure as described herein. For example, the communications manager 804, the receiver 810, the transmitter 812, or various combinations or components thereof may support a method for performing one or more of the functions described herein.

In some implementations, the communications manager 804, the receiver 810, the transmitter 812, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 806 and the memory 808 coupled with the processor 806 may be configured to perform one or more of the functions described herein (e.g., by executing, by the processor 806, instructions stored in the memory 808).

Additionally or alternatively, in some implementations, the communications manager 804, the receiver 810, the transmitter 812, or various combinations or components thereof may be implemented in code (e.g., as communications management software or firmware) executed by the processor 806. If implemented in code executed by the processor 806, the functions of the communications manager 804, the receiver 810, the transmitter 812, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 804 may be configured to perform various operations (e.g., receiving, monitoring, transmitting) using or otherwise in cooperation with the receiver 810, the transmitter 812, or both. For example, the communications manager 804 may receive information from the receiver 810, send information to the transmitter 812, or be integrated in combination with the receiver 810, the transmitter 812, or both to receive information, transmit information, or perform various other operations as described herein. Although the communications manager 804 is illustrated as a separate component, in some implementations, one or more functions described with reference to the communications manager 804 may be supported by or performed by the processor 806, the memory 808, or any combination thereof. For example, the memory 808 may store code, which may include instructions executable by the processor 806 to cause the device 802 to perform various aspects of the present disclosure as described herein, or the processor 806 and the memory 808 may be otherwise configured to perform or support such operations.

For example, the communications manager 804 may support wireless communication and/or network signaling at a device (e.g., the device 802, a base station) in accordance with examples as disclosed herein. The communications manager 804 and/or other device components may be configured as or otherwise support an apparatus, such as a base station, including a transceiver; a processor coupled to the transceiver, the processor and the transceiver configured to cause the apparatus to: receive a first notification including a first indication of signal interference and first RIS configuration information; generate second RIS configuration information based at least in part on the first RIS configuration information, and configure operation of an RIS based on the second RIS configuration information; receive a second notification including a second indication of signal interference; and configure operation of the RIS based at least in part on the second indication of signal interference.

Additionally, the apparatus (e.g., a base station) includes any one or combination of: where the first indication of signal interference includes one or more of an indication of an amount of signal interference, an indication of a coverage area affected by the signal interference, or a direction of one or more interfering signals; where the first RIS configuration information includes a power reduction request to be applied to the RIS; where the first RIS configuration information includes a an OFF pattern to be applied to the RIS; where the first notification is received from a network node, and where the processor and the transceiver are further configured to cause the apparatus to generate third RIS configuration information that includes an OFF pattern of the RIS, and transmit the third RIS configuration information to the network node; where the first RIS configuration information includes an OFF pattern to be applied to the RIS, and where the processor is configured to cause the apparatus to generate the second RIS configuration information to identify one or more time slots to be switched OFF by the RIS;

Additionally, the apparatus (e.g., a base station) includes any one or combination of: where the processor is configured to cause the apparatus to generate the second RIS configuration information to include coefficients to apply signal absorption at the one or more time slots and based on the OFF pattern; where the first indication of signal interference includes one or more of an indication of a coverage area affected by the signal interference or a direction of one or more interfering signals, and where the processor is configured to cause the apparatus to generate the second RIS configuration information to include a coefficients update to be applied by the RIS to reduce signal interference at the one or more of the coverage area affected by the signal interference or the direction of the one or more interfering signals; where the first indication of signal interference includes one or more of an indication of a coverage area affected by the signal interference or a direction of one or more interfering signals, and where the processor is configured to cause the apparatus to generate the second RIS configuration information to include a power reduction instruction to be applied by the RIS to reduce signal interference at the one or more of the coverage area affected by the signal interference or the direction of the one or more interfering signals.

The communications manager 804 and/or other device components may be configured as or otherwise support a means for wireless communication and/or network signaling at a base station, including receiving a first notification including a first indication of signal interference and first RIS configuration information; generating second RIS configuration information based at least in part on the first RIS configuration information, and configuring operation of an RIS based on the second RIS configuration information; receiving a second notification including a second indication of signal interference; and configuring operation of the RIS based at least in part on the second indication of signal interference.

Additionally, wireless communication at the base station includes any one or combination of: where the first indication of signal interference includes one or more of an indication of an amount of signal interference, an indication of a coverage area affected by the signal interference, or a direction of one or more interfering signals; where the first RIS configuration information includes a power reduction request to be applied to the RIS; where the first RIS configuration information includes a an OFF pattern to be applied to the RIS; where the first notification is received from a network node, and generating third RIS configuration information that includes an OFF pattern of the RIS, and transmitting the third RIS configuration information to the network node; where the first RIS configuration information includes an OFF pattern to be applied to the RIS, and generating the second RIS configuration information to identify one or more time slots to be switched OFF by the RIS.

Additionally, wireless communication at the base station includes any one or combination of: generating the second RIS configuration information to include coefficients to apply signal absorption at the one or more time slots and based on the OFF pattern; where the first indication of signal interference includes one or more of an indication of a coverage area affected by the signal interference or a direction of one or more interfering signals, and generating the second RIS configuration information to include a coefficients update to be applied by the RIS to reduce signal interference at the one or more of the coverage area affected by the signal interference or the direction of the one or more interfering signals; where the first indication of signal interference includes one or more of an indication of a coverage area affected by the signal interference or a direction of one or more interfering signals, and generating the second RIS configuration information to include a power reduction instruction to be applied by the RIS to reduce signal interference at the one or more of the coverage area affected by the signal interference or the direction of the one or more interfering signals.

Additionally, the communications manager 804 and/or other device components may be configured as or otherwise support an apparatus, such as a base station, including a transceiver; a processor coupled to the transceiver, the processor and the transceiver configured to cause the apparatus to: receive from a UE a first measurement report including a first indication of signal interference; generate first RIS configuration information and transmit, to a second network node, a first notification that includes the first indication of signal interference and the first RIS configuration information; generate signal measurement configuration information based at least in part on the first RIS configuration information, and transmit the signal measurement configuration information to the UE; receive from the UE a second measurement report including a second indication of signal interference based on applying the signal measurement configuration information at the UE; and generate a second notification that includes the second indication of signal interference, and transmit the second notification to the second network node.

Additionally, the apparatus (e.g., a base station) includes any one or combination of: where the processor is configured to cause the apparatus to generate, based on the first indication of signal interference, the first notification to include one or more of an indication of an amount of signal interference, an indication of a coverage area affected by the signal interference, or a direction of one or more interfering signals; where the processor is configured to cause the apparatus to generate the first RIS configuration information to include a power reduction request to be applied to an RIS; where the processor is configured to cause the apparatus to generate the first RIS configuration information to include an OFF pattern to be applied to an RIS; where the processor and the transceiver are configured to cause the apparatus to: receive from the second network node an indication of an OFF pattern identifying time slots at which an RIS is in an OFF state; and generate the signal measurement configuration information based on the indication of the OFF pattern; where the processor is configured to generate the signal measurement configuration information to include an instruction for the UE to measure signal interference based on the OFF pattern to indicate signal interference detected when the OFF pattern indicates that the RIS is OFF and signal interference detected when the OFF pattern indicates that the RIS is ON; where the second measurement report includes interference measurements for interference detected based on the OFF pattern, and the processor is configured to cause the apparatus to generate the second notification to include an indication of the interference measurements for interference detected based on the OFF pattern.

The communications manager 804 and/or other device components may be configured as or otherwise support a means for wireless communication and/or network signaling at a base station, including receiving from a UE a first measurement report including a first indication of signal interference; generating first RIS configuration information and transmitting, to a second network node, a first notification that includes the first indication of signal interference and the first RIS configuration information; generating signal measurement configuration information based at least in part on the first RIS configuration information, and transmitting the signal measurement configuration information to the UE; receiving from the UE a second measurement report including a second indication of signal interference based on applying the signal measurement configuration information at the UE; and generating a second notification that includes the second indication of signal interference, and transmit the second notification to the second network node.

Additionally, wireless communication at the base station includes any one or combination of: generating, based on the first indication of signal interference, the first notification to include one or more of an indication of an amount of signal interference, an indication of a coverage area affected by the signal interference, or a direction of one or more interfering signals; generating the first RIS configuration information to include a power reduction request to be applied to an RIS; generating the first RIS configuration information to include an OFF pattern to be applied to an RIS; receiving from the second network node an indication of an OFF pattern identifying time slots at which an RIS is in an OFF state; and generating the signal measurement configuration information based on the indication of the OFF pattern; generating the signal measurement configuration information to include an instruction for the UE to measure signal interference based on the OFF pattern to indicate signal interference detected when the OFF pattern indicates that the RIS is OFF and signal interference detected when the OFF pattern indicates that the RIS is ON; where the second measurement report includes interference measurements for interference detected based on the OFF pattern, and generating the second notification to include an indication of the interference measurements for interference detected based on the OFF pattern.

Additionally, the communications manager 804 and/or other device components may be configured as or otherwise support an apparatus, such as a base station, including a transceiver; a processor coupled to the transceiver, the processor and the transceiver configured to cause the apparatus to: receive from a UE a first measurement report including a first indication of signal interference; transmit, to a control function associated with an RIS of a wireless network, the first indication of signal interference; receive from the UE a second measurement report including a second indication of signal interference based on applying signal measurement configuration information at the UE; and transmit the second indication of signal interference to the control function associated with the RIS of the wireless network.

Additionally, the apparatus (e.g., a base station) includes any one or combination of: where one or more of the first indication of signal interference or the second indication of signal interference indicates cross time slot signal interference experienced at the UE; where the processor and the transceiver are configured to cause the apparatus to: compare the first indication of signal interference to a signal interference threshold; and transmit, to the control function associated with the RIS of the wireless network, the first indication of signal interference based on the first indication of signal interference exceeding the signal interference threshold; where the processor and the transceiver are configured to cause the apparatus to: determine a coverage area affected by the first indication of signal interference; and transmit, to the control function associated with the RIS of the wireless network, an indication of the determined coverage area; where the processor and the transceiver are configured to cause the apparatus to: determine direction of arrival information for signal associated with the first indication of signal interference; and transmit, to the control function associated with the RIS of the wireless network, the direction of arrival information.

The communications manager 804 and/or other device components may be configured as or otherwise support a means for wireless communication and/or network signaling at a base station, including receiving from a UE a first measurement report including a first indication of signal interference; transmitting, to a control function associated with an RIS of a wireless network, the first indication of signal interference; receiving from the UE a second measurement report including a second indication of signal interference based on applying signal measurement configuration information at the UE; and transmitting the second indication of signal interference to the control function associated with the RIS of the wireless network.

Additionally, wireless communication at the base station includes any one or combination of: where one or more of the first indication of signal interference or the second indication of signal interference indicates cross time slot signal interference experienced at the UE; comparing the first indication of signal interference to a signal interference threshold; and transmitting, to the control function associated with the RIS of the wireless network, the first indication of signal interference based on the first indication of signal interference exceeding the signal interference threshold; determining a coverage area affected by the first indication of signal interference; and transmitting, to the control function associated with the RIS of the wireless network, an indication of the determined coverage area; determining direction of arrival information for signal associated with the first indication of signal interference; and transmitting, to the control function associated with the RIS of the wireless network, the direction of arrival information.

Additionally, the communications manager 804 may support wireless communication and/or network signaling at a device (e.g., the device 802, a base station) in accordance with examples as disclosed herein. The communications manager 804 and/or other device components may be configured as or otherwise support an apparatus, such as a base station, including a transceiver; a processor coupled to the transceiver, the processor and the transceiver configured to cause the apparatus to: generate a RIS request that requests access to at least a portion of an RIS, and transmit the RIS request; receive a request response including RIS access configuration information for enabling access to the at least a portion of the RIS; and establish connectivity with the RIS based at least in part on the RIS access configuration information.

Additionally, the apparatus (e.g., a base station) includes any one or combination of: where the processor and the transceiver are configured to cause the apparatus to generate the RIS request to indicate one or more of a number of instances of user equipment that are associated with the RIS request, or a target service area associated with the RIS request; where the processor and the transceiver are configured to cause the apparatus to generate the RIS request to indicate a priority of the RIS request based on one or more of a number of instances of user equipment that are associated with the RIS request, or a target service area associated with the RIS request; where the processor and the transceiver are configured to cause the apparatus to receive the request response as an acknowledgement response indicating permission to access the at least a portion of the RIS or a non-acknowledgement response indicating no permission to access the at least a portion of the RIS; where the processor and the transceiver are configured to cause the apparatus to transmit the RIS request to an RIS control function at a central unit of a wireless network, and receive the request response from the RIS control function; where the processor and the transceiver are configured to cause the apparatus to receive one or more measurement reports indicating signal quality measured at one or more instances of user equipment, and generate and transmit the RIS request based on the one or more measurement reports indicating that the signal quality is below a signal quality threshold; where the RIS access configuration information includes one or more of time slot information for access to the RIS, or time scheduling information for time slots for access to the RIS; where the RIS access configuration information includes an indication of a segment of the RIS that is available, and where the processor and the transceiver are configured to cause the apparatus to establish connectivity with the RIS and utilize the segment of the RIS for connectivity with one or more UEs.

The communications manager 804 and/or other device components may be configured as or otherwise support a means for wireless communication and/or network signaling at a base station, including generating a RIS request that requests access to at least a portion of an RIS, and transmitting the RIS request; receiving a request response including RIS access configuration information for enabling access to the at least a portion of the RIS; and establishing connectivity with the RIS based at least in part on the RIS access configuration information.

Additionally, wireless communication at the includes any one or combination of: generating the RIS request to indicate one or more of a number of instances of user equipment that are associated with the RIS request, or a target service area associated with the RIS request; generating the RIS request to indicate a priority of the RIS request based on one or more of a number of instances of user equipment that are associated with the RIS request, or a target service area associated with the RIS request; receiving the request response as an acknowledgement response indicating permission to access the at least a portion of the RIS, or a non-acknowledgement response indicating no permission to access the at least a portion of the RIS; transmitting the RIS request to an RIS control function at a central unit of a wireless network, and receiving the request response from the RIS control function; causing the apparatus to receive one or more measurement reports indicating signal quality measured at one or more instances of user equipment, and generating and transmit the RIS request based on the one or more measurement reports indicating that the signal quality is below a signal quality threshold; where the RIS access configuration information includes one or more of time slot information for access to the RIS, or time scheduling information for time slots for access to the RIS; where the RIS access configuration information includes an indication of a segment of the RIS that is available, and establishing connectivity with the RIS and utilize the segment of the RIS for connectivity with one or more UEs.

Additionally, the communications manager 804 may support wireless communication and/or network signaling at a device (e.g., the device 802, a base station) in accordance with examples as disclosed herein. The communications manager 804 and/or other device components may be configured as or otherwise support an apparatus, such as a base station, including a transceiver; a processor coupled to the transceiver, the processor and the transceiver configured to cause the apparatus to: receive a RIS request that requests access to at least a portion of an RIS; generate a request response including RIS access configuration information for enabling access to the at least a portion of the RIS; and transmit the request response.

Additionally, the apparatus (e.g., a base station) includes any one or combination of: where the RIS request includes one or more of a number of instances of user equipment that are associated with the RIS request, a target service area associated with the RIS request, or a priority of the RIS request; where the apparatus includes a first network node, the RIS request identifies a second network node, and where the processor and the transceiver are configured to cause the apparatus to transmit a connection notification to the RIS to establish a connection with the second network node; where the processor and the transceiver are configured to cause the apparatus to transmit a termination notification to the RIS to terminate a connection to the first network node.

Additionally, the apparatus (e.g., a base station) includes any one or combination of: where the processor and the transceiver are configured to cause the apparatus to generate the connection notification to include connectivity information for connecting the RIS to the second network node; where the RIS request is received from an RIS control function at a central unit of a wireless network, and where the processor and the transceiver are configured to cause the apparatus to transmit the request response to the RIS control function at the central unit; where the apparatus includes a first network node associated with the RIS, and the RIS request includes an instruction from the RIS control function for the first network node to cause the RIS to establish connectivity with a second network node; where the processor and the transceiver are configured to: determine, based on one or more measurement reports from one or more UEs, that the at least a portion of the RIS is allocatable; and generate the request response to indicate that the at least a portion of the RIS is available; where the processor and the transceiver are configured to: determine that the RIS is to be segmented into multiple segments; and transmit a notification to the RIS to segment the RIS into multiple segments and to establish connectivity with multiple network nodes via the multiple segments.

The communications manager 804 and/or other device components may be configured as or otherwise support a means for wireless communication and/or network signaling at a base station, including receiving a RIS request that requests access to at least a portion of an RIS; generating a request response including RIS access configuration information for enabling access to the at least a portion of the RIS; and transmitting the request response.

Additionally, wireless communication at the base station includes any one or combination of: where the RIS request includes one or more of a number of instances of user equipment that are associated with the RIS request, a target service area associated with the RIS request, or a priority of the RIS request; where the method is performed by a first network node, the RIS request identifies a second network node, and transmitting a connection notification to the RIS to establish a connection with the second network node; causing the apparatus to transmit a termination notification to the RIS to terminate a connection to the first network node; generating the connection notification to include connectivity information for connecting the RIS to the second network node; where the RIS request is received from an RIS control function at a central unit of a wireless network, and transmitting the request response to the RIS control function at the central unit; where the method is performed by a first network node associated with the RIS, and the RIS request includes an instruction from the RIS control function for the first network node to cause the RIS to establish connectivity with a second network node; determining, based on one or more measurement reports from one or more UEs, that the at least a portion of the RIS is allocatable; and generating the request response to indicate that the at least a portion of the RIS is available; determining that the RIS is to be segmented into multiple segments; and transmitting a notification to the RIS to segment the RIS into multiple segments and to establish connectivity with multiple network nodes via the multiple segments.

The processor 806 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 806 may be configured to operate a memory array using a memory controller. In some other implementations, a memory controller may be integrated into the processor 806. The processor 806 may be configured to execute computer-readable instructions stored in a memory (e.g., the memory 808) to cause the device 802 to perform various functions of the present disclosure.

The memory 808 may include random access memory (RAM) and read-only memory (ROM). The memory 808 may store computer-readable, computer-executable code including instructions that, when executed by the processor 806 cause the device 802 to perform various functions described herein. The code may be stored in a non-transitory computer-readable medium such as system memory or another type of memory. In some implementations, the code may not be directly executable by the processor 806 but may cause a computer (e.g., when compiled and executed) to perform functions described herein. In some implementations, the memory 808 may include, among other things, a basic I/O system (BIOS) which may control basic hardware or software operation such as the interaction with peripheral components or devices.

The I/O controller 814 may manage input and output signals for the device 802. The I/O controller 814 may also manage peripherals not integrated into the device 802. In some implementations, the I/O controller 814 may represent a physical connection or port to an external peripheral. In some implementations, the I/O controller 814 may utilize an operating system such as iOS®, ANDROID®, MS-DOS®, MS-WINDOWS®, OS/2®, UNIX®, LINUX®, or another known operating system. In some implementations, the I/O controller 814 may be implemented as part of a processor, such as the processor 806. In some implementations, a user may interact with the device 802 via the I/O controller 814 or via hardware components controlled by the I/O controller 814.

In some implementations, the device 802 may include a single antenna 816. However, in some other implementations, the device 802 may have more than one antenna 816, which may be capable of concurrently transmitting or receiving multiple wireless transmissions. The receiver 810 and the transmitter 812 may communicate bi-directionally, via the one or more antennas 816, wired, or wireless links as described herein. For example, the receiver 810 and the transmitter 812 may represent a wireless transceiver and may communicate bi-directionally with another wireless transceiver. The transceiver may also include a modem to modulate the packets, to provide the modulated packets to one or more antennas 816 for transmission, and to demodulate packets received from the one or more antennas 816.

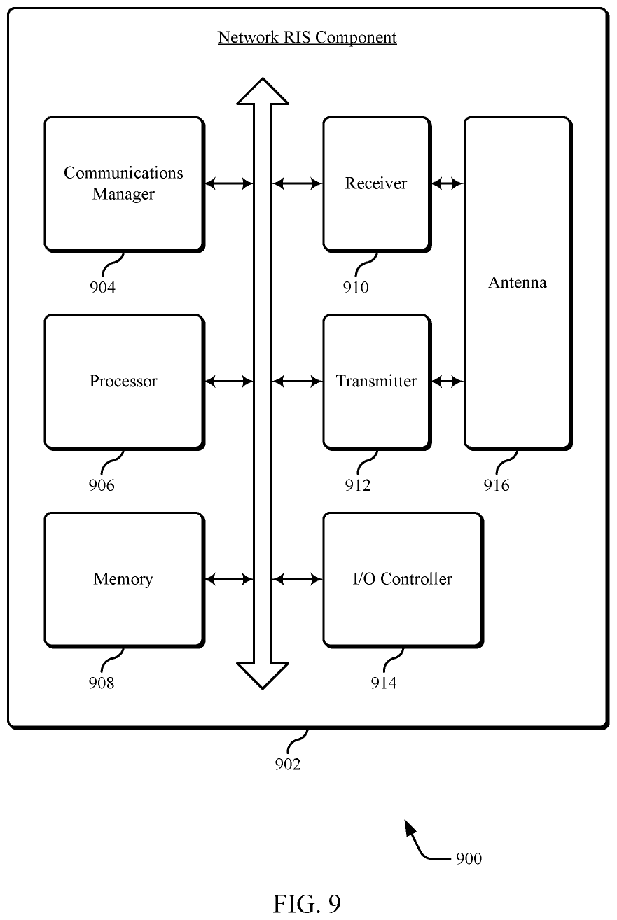

FIG. 9 illustrates an example of a block diagram 900 of a device 902 that supports RIS management in wireless systems in accordance with aspects of the present disclosure. The device 902 may be an example of a network RIS component 120 as described herein. The device 902 may support wireless communication and/or network signaling with one or more base stations 102, other UEs 104, core network devices and functions (e.g., core network 106), or any combination thereof. The device 902 may include components for bi-directional communications including components for transmitting and receiving communications, such as a communications manager 904, a processor 906, a memory 908, a receiver 910, a transmitter 912, and an I/O controller 914. These components may be in electronic communication or otherwise coupled (e.g., operatively, communicatively, functionally, electronically, electrically) via one or more interfaces (e.g., buses).

The communications manager 904, the receiver 910, the transmitter 912, or various combinations thereof or various components thereof may be examples of means for performing various aspects of the present disclosure as described herein. For example, the communications manager 904, the receiver 910, the transmitter 912, or various combinations or components thereof may support a method for performing one or more of the functions described herein.

In some implementations, the communications manager 904, the receiver 910, the transmitter 912, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 906 and the memory 908 coupled with the processor 906 may be configured to perform one or more of the functions described herein (e.g., by executing, by the processor 906, instructions stored in the memory 908).

Additionally or alternatively, in some implementations, the communications manager 904, the receiver 910, the transmitter 912, or various combinations or components thereof may be implemented in code (e.g., as communications management software or firmware) executed by the processor 906. If implemented in code executed by the processor 906, the functions of the communications manager 904, the receiver 910, the transmitter 912, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 904 may be configured to perform various operations (e.g., receiving, monitoring, transmitting) using or otherwise in cooperation with the receiver 910, the transmitter 912, or both. For example, the communications manager 904 may receive information from the receiver 910, send information to the transmitter 912, or be integrated in combination with the receiver 910, the transmitter 912, or both to receive information, transmit information, or perform various other operations as described herein. Although the communications manager 904 is illustrated as a separate component, in some implementations, one or more functions described with reference to the communications manager 904 may be supported by or performed by the processor 906, the memory 908, or any combination thereof. For example, the memory 908 may store code, which may include instructions executable by the processor 906 to cause the device 902 to perform various aspects of the present disclosure as described herein, or the processor 906 and the memory 908 may be otherwise configured to perform or support such operations.

For example, the communications manager 904 may support wireless communication and/or network signaling at a device (e.g., the device 902, a network RIS component) in accordance with examples as disclosed herein. The communications manager 904 and/or other device components may be configured as or otherwise support an apparatus, such as a network RIS component, including a transceiver; a processor coupled to the transceiver, the processor and the transceiver configured to cause the apparatus to: receive from a first network node an indication of signal interference associated with a UE; generate first RIS configuration information and transmit, to a second network node associated with an RIS, a first notification including the indication of signal interference and the first RIS configuration information; receive from the first network node an updated indication of signal interference associated with the UE; and generate second RIS configuration information based on the updated indication of signal interference associated with the UE, and transmit, to the second network node, a second notification including the second RIS configuration information.

Additionally, the apparatus (e.g., a network RIS component) includes any one or combination of: where the apparatus includes a central unit associated with a wireless network, and the control function includes an RIS control function implemented at the central unit; where the processor is configured to cause the apparatus to generate one or more of the first RIS configuration information or the second RIS configuration information to include a power reduction instruction for the RIS; where the processor and the transceiver are configured to cause the apparatus to: generate the first RIS configuration information to include an OFF pattern to be applied to the RIS; generate a third notification that identifies the OFF pattern, and transmit the third notification to the first network node for use by the UE in detecting whether signal interference is caused by the RIS.

The communications manager 904 and/or other device components may be configured as or otherwise support a means for wireless communication and/or network signaling at a network RIS component, including receiving from a first network node an indication of signal interference associated with a UE; generating first RIS configuration information and transmitting, to a second network node associated with an RIS, a first notification including the indication of signal interference and the first RIS configuration information; receiving from the first network node an updated indication of signal interference associated with the UE; and generating second RIS configuration information based on the updated indication of signal interference associated with the UE, and transmitting, to the second network node, a second notification including the second RIS configuration information.

Additionally, wireless communication at the network RIS component includes any one or combination of: where the method is implemented by a central unit associated with a wireless network, and the control function includes an RIS control function implemented at the central unit; generating one or more of the first RIS configuration information or the second RIS configuration information to include a power reduction instruction for the RIS; generating the first RIS configuration information to include an OFF pattern to be applied to the RIS; generating a third notification that identifies the OFF pattern, and transmitting the third notification to the first network node for use by the UE in detecting whether signal interference is caused by the RIS.

The communications manager 904 and/or other device components may also be configured as or otherwise support an apparatus, such as a network RIS component, including a transceiver; a processor coupled to the transceiver, the processor and the transceiver configured to cause the apparatus to: receive from a first network node a first RIS request requesting access to at least a portion of an RIS; generate a second RIS request based at least in part on the first RIS request, and transmit the second RIS request to a second network node associated with the RIS; and receive from the second network node a request response including access configuration information for the first network node to access the RIS.

Additionally, the apparatus (e.g., a network RIS component) includes any one or combination of: where the processor and the transceiver are configured to cause the apparatus to generate a second request response that includes at least some of the access configuration information, and transmit the second request response to the first network node; where the processor and the transceiver are configured to cause the apparatus to generate an instruction for the second network node to cause the RIS to establish connectivity with the first network node, and transmit the instruction to the second network node; where the processor and the transceiver are configured to cause the apparatus to generate the instruction to indicate that that second network node is to cause the RIS to segment the RIS into two or more segments, and cause the RIS to establish connectivity with the first network node via one or more segments of the two or more segments.

The communications manager 904 and/or other device components may be configured as or otherwise support a means for wireless communication and/or network signaling at a network RIS component, including receiving from a first network node a first RIS request requesting access to at least a portion of an RIS; generating a second RIS request based at least in part on the first RIS request, and transmitting the second RIS request to a second network node associated with the RIS; and receiving from the second network node a request response including access configuration information for the first network node to access the RIS.

Additionally, wireless communication at the network RIS component includes any one or combination of: generating a second request response that includes at least some of the access configuration information, and transmitting the second request response to the first network node; generating an instruction for the second network node to cause the RIS to establish connectivity with the first network node, and transmitting the instruction to the second network node; generating the instruction to indicate that that second network node is to cause the RIS to segment the RIS into two or more segments, and cause the RIS to establish connectivity with the first network node via a first segment of the two or more segments.

The processor 906 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 906 may be configured to operate a memory array using a memory controller. In some other implementations, a memory controller may be integrated into the processor 906. The processor 906 may be configured to execute computer-readable instructions stored in a memory (e.g., the memory 908) to cause the device 902 to perform various functions of the present disclosure.

The memory 908 may include random access memory (RAM) and read-only memory (ROM). The memory 908 may store computer-readable, computer-executable code including instructions that, when executed by the processor 906 cause the device 902 to perform various functions described herein. The code may be stored in a non-transitory computer-readable medium such as system memory or another type of memory. In some implementations, the code may not be directly executable by the processor 906 but may cause a computer (e.g., when compiled and executed) to perform functions described herein. In some implementations, the memory 908 may include, among other things, a basic I/O system (BIOS) which may control basic hardware or software operation such as the interaction with peripheral components or devices.

The I/O controller 914 may manage input and output signals for the device 902. The I/O controller 914 may also manage peripherals not integrated into the device 902. In some implementations, the I/O controller 914 may represent a physical connection or port to an external peripheral. In some implementations, the I/O controller 914 may utilize an operating system such as iOS®, ANDROID®, MS-DOS®, MS-WINDOWS®, OS/2®, UNIX®, LINUX®, or another known operating system. In some implementations, the I/O controller 914 may be implemented as part of a processor, such as the processor 906. In some implementations, a user may interact with the device 902 via the I/O controller 914 or via hardware components controlled by the I/O controller 914.

In some implementations, the device 902 may include a single antenna 916. However, in some other implementations, the device 902 may have more than one antenna 916, which may be capable of concurrently transmitting or receiving multiple wireless transmissions. The receiver 910 and the transmitter 912 may communicate bi-directionally, via the one or more antennas 916, wired, or wireless links as described herein. For example, the receiver 910 and the transmitter 912 may represent a wireless transceiver and may communicate bi-directionally with another wireless transceiver. The transceiver may also include a modem to modulate the packets, to provide the modulated packets to one or more antennas 916 for transmission, and to demodulate packets received from the one or more antennas 916.

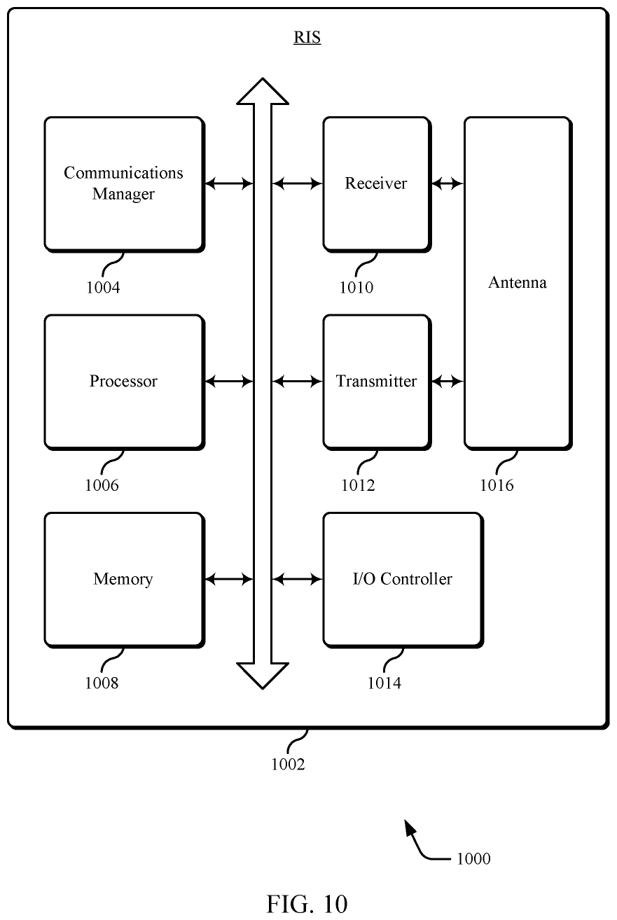

FIG. 10 illustrates an example of a block diagram 1000 of a device 1002 that supports RIS management in wireless systems in accordance with aspects of the present disclosure. The device 1002 may be an example of an RIS 118 as described herein. The device 1002 may support wireless communication and/or network signaling with one or more base stations 102, UEs 104, network entities and devices, or any combination thereof. The device 1002 may include components for bi-directional communications including components for transmitting and receiving communications, such as a communications manager 1004, a processor 1006, a memory 1008, a receiver 1010, a transmitter 1012, and an I/O controller 1014. These components may be in electronic communication or otherwise coupled (e.g., operatively, communicatively, functionally, electronically, electrically) via one or more interfaces (e.g., buses).

The communications manager 1004, the receiver 1010, the transmitter 1012, or various combinations thereof or various components thereof may be examples of means for performing various aspects of the present disclosure as described herein. For example, the communications manager 1004, the receiver 1010, the transmitter 1012, or various combinations or components thereof may support a method for performing one or more of the functions described herein.

In some implementations, the communications manager 1004, the receiver 1010, the transmitter 1012, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1006 and the memory 1008 coupled with the processor 1006 may be configured to perform one or more of the functions described herein (e.g., by executing, by the processor 1006, instructions stored in the memory 1008).

Additionally or alternatively, in some implementations, the communications manager 1004, the receiver 1010, the transmitter 1012, or various combinations or components thereof may be implemented in code (e.g., as communications management software or firmware) executed by the processor 1006. If implemented in code executed by the processor 1006, the functions of the communications manager 1004, the receiver 1010, the transmitter 1012, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 1004 may be configured to perform various operations (e.g., receiving, monitoring, transmitting) using or otherwise in cooperation with the receiver 1010, the transmitter 1012, or both. For example, the communications manager 1004 may receive information from the receiver 1010, send information to the transmitter 1012, or be integrated in combination with the receiver 1010, the transmitter 1012, or both to receive information, transmit information, or perform various other operations as described herein. Although the communications manager 1004 is illustrated as a separate component, in some implementations, one or more functions described with reference to the communications manager 1004 may be supported by or performed by the processor 1006, the memory 1008, or any combination thereof. For example, the memory 1008 may store code, which may include instructions executable by the processor 1006 to cause the device 1002 to perform various aspects of the present disclosure as described herein, or the processor 1006 and the memory 1008 may be otherwise configured to perform or support such operations.

For example, the communications manager 1004 may support wireless communication and/or network signaling at a device in accordance with examples as disclosed herein. The communications manager 1004 and/or other device components may be configured as or otherwise support an apparatus, such as an RIS, including a transceiver; a processor coupled to the transceiver, the processor and the transceiver configured to cause the apparatus to: receive, from a first network node, access information for access to a second network node; communicate, based on the access information, with the second network node to establish connectivity with the second network node; and receive, from the second network node, configuration information for configuring connectivity between the RIS and the second network node.

Additionally, the apparatus (e.g., an RIS) includes any one or combination of: where the processor and the transceiver are configured to cause the RIS to establish connectivity with the second network node based at least in part on the configuration information; where the processor and the transceiver are configured to cause the RIS to terminate connectivity with the first network node; where the processor and the transceiver are configured to cause the RIS to: segment, based on the configuration information, the RIS into two or more segments; and establish connectivity with the second network node via a first segment of the two or more segments; where the processor and the transceiver are configured to cause the RIS to establish dual connectivity between the first network node and the second network node via the two or more segments; where the processor and the transceiver are configured to cause the RIS to establish dual connectivity between the first network node and the second network node by allocating different respective time slots to the first network node and the second network node.

The communications manager 1004 and/or other device components may be configured as or otherwise support a means for wireless communication and/or network signaling at a UE, including receiving, from a first network node, access information for access to a second network node; communicating, based on the access information, with the second network node to establish connectivity with the second network node; and receiving, from the second network node, configuration information for configuring connectivity between the RIS and the second network node.

Additionally, wireless communication and/or network signaling at the RIS includes any one or combination of: establishing connectivity with the second network node based at least in part on the configuration information; terminating connectivity with the first network node; segmenting, based on the configuration information, the RIS into two or more segments; and establishing connectivity with the second network node via a first segment of the two or more segments; establishing dual connectivity between the first network node and the second network node via the two or more segments; establishing dual connectivity between the first network node and the second network node by allocating different respective time slots to the first network node and the second network node.

The processor 1006 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1006 may be configured to operate a memory array using a memory controller. In some other implementations, a memory controller may be integrated into the processor 1006. The processor 1006 may be configured to execute computer-readable instructions stored in a memory (e.g., the memory 1008) to cause the device 1002 to perform various functions of the present disclosure.

The memory 1008 may include random access memory (RAM) and read-only memory (ROM). The memory 1008 may store computer-readable, computer-executable code including instructions that, when executed by the processor 1006 cause the device 1002 to perform various functions described herein. The code may be stored in a non-transitory computer-readable medium such as system memory or another type of memory. In some implementations, the code may not be directly executable by the processor 1006 but may cause a computer (e.g., when compiled and executed) to perform functions described herein. In some implementations, the memory 1008 may include, among other things, a basic I/O system (BIOS) which may control basic hardware or software operation such as the interaction with peripheral components or devices.

The I/O controller 1014 may manage input and output signals for the device 1002. The I/O controller 1014 may also manage peripherals not integrated into the device 1002. In some implementations, the I/O controller 1014 may represent a physical connection or port to an external peripheral. In some implementations, the I/O controller 1014 may utilize an operating system such as iOS®, ANDROID®, MS-DOS®, MS-WINDOWS®, OS/2®, UNIX®, LINUX®, or another known operating system. In some implementations, the I/O controller 1014 may be implemented as part of a processor, such as the processor 1006. In some implementations, a user may interact with the device 1002 via the I/O controller 1014 or via hardware components controlled by the I/O controller 1014.

In some implementations, the device 1002 may include a single antenna 1016. However, in some other implementations, the device 1002 may have more than one antenna 1016, which may be capable of concurrently transmitting or receiving multiple wireless transmissions. The receiver 1010 and the transmitter 1012 may communicate bi-directionally, via the one or more antennas 1016, wired, or wireless links as described herein. For example, the receiver 1010 and the transmitter 1012 may represent a wireless transceiver and may communicate bi-directionally with another wireless transceiver. The transceiver may also include a modem to modulate the packets, to provide the modulated packets to one or more antennas 1016 for transmission, and to demodulate packets received from the one or more antennas 1016.

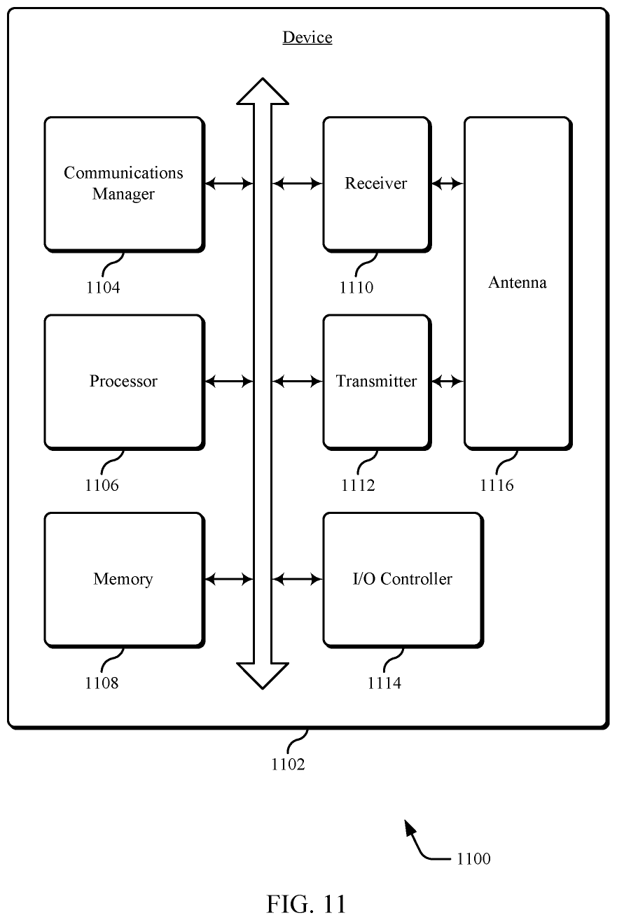

FIG. 11 illustrates an example of a block diagram 1100 of a device 1102 that supports RIS management in wireless systems in accordance with aspects of the present disclosure. The device 1102 may be an example of a UE 104 as described herein. The device 1102 may support wireless communication and/or network signaling with one or more base stations 102, other UEs 104, network entities and devices, or any combination thereof. The device 1102 may include components for bi-directional communications including components for transmitting and receiving communications, such as a communications manager 1104, a processor 1106, a memory 1108, a receiver 1110, a transmitter 1112, and an I/O controller 1114. These components may be in electronic communication or otherwise coupled (e.g., operatively, communicatively, functionally, electronically, electrically) via one or more interfaces (e.g., buses).

The communications manager 1104, the receiver 1110, the transmitter 1112, or various combinations thereof or various components thereof may be examples of means for performing various aspects of the present disclosure as described herein. For example, the communications manager 1104, the receiver 1110, the transmitter 1112, or various combinations or components thereof may support a method for performing one or more of the functions described herein.

In some implementations, the communications manager 1104, the receiver 1110, the transmitter 1112, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1106 and the memory 1108 coupled with the processor 1106 may be configured to perform one or more of the functions described herein (e.g., by executing, by the processor 1106, instructions stored in the memory 1108).

Additionally or alternatively, in some implementations, the communications manager 1104, the receiver 1110, the transmitter 1112, or various combinations or components thereof may be implemented in code (e.g., as communications management software or firmware) executed by the processor 1106. If implemented in code executed by the processor 1106, the functions of the communications manager 1104, the receiver 1110, the transmitter 1112, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 1104 may be configured to perform various operations (e.g., receiving, monitoring, transmitting) using or otherwise in cooperation with the receiver 1110, the transmitter 1112, or both. For example, the communications manager 1104 may receive information from the receiver 1110, send information to the transmitter 1112, or be integrated in combination with the receiver 1110, the transmitter 1112, or both to receive information, transmit information, or perform various other operations as described herein. Although the communications manager 1104 is illustrated as a separate component, in some implementations, one or more functions described with reference to the communications manager 1104 may be supported by or performed by the processor 1106, the memory 1108, or any combination thereof. For example, the memory 1108 may store code, which may include instructions executable by the processor 1106 to cause the device 1102 to perform various aspects of the present disclosure as described herein, or the processor 1106 and the memory 1108 may be otherwise configured to perform or support such operations.

For example, the communications manager 1104 may support wireless communication and/or network signaling at a device (e.g., the device 1102, a UE) in accordance with examples as disclosed herein. The communications manager 1104 and/or other device components may be configured as or otherwise support an apparatus, such as a UE, including a transceiver; a processor coupled to the transceiver, the processor and the transceiver configured to cause the apparatus to: generate a first measurement report that includes an indication of signal interference, and transmit the first measurement report to a network node; receive, from the network node, signal measurement configuration information configured for detecting interference caused by an RIS; apply the signal measurement configuration information and measure signal attributes of signal received at the UE with the signal measurement configuration information applied; and generate a second measurement report that includes the measured signal attributes, and transmit the second measurement report to the network node.

Additionally, the apparatus (e.g., a UE) includes any one or combination of: where the signal measurement configuration information includes an indication of an OFF pattern identifying time slots at which an RIS is in an OFF state, and where the processor and the transceiver are configured to cause the UE to: measure signal interference of the signal received at the UE based on the indication of the OFF pattern; and generate the second measurement report to include measurements for signal interference measured based on the indication of the OFF pattern; where the processor and the transceiver are configured to cause the UE to: determine direction of arrival information for the signal received at the UE; and generate the second measurement report to include the direction of arrival information; where the processor and the transceiver are configured to cause the UE to measure signal interference of signal received at the UE based on: first signal interference measurements for time slots where the OFF pattern indicates that the RIS is in an OFF state; and second signal interference measurements for time slots where the OFF pattern indicates that the RIS is in an ON state; where the processor and the transceiver are configured to cause the UE to: generate a first measurement sub-report based on an average value of the first signal interference measurements; generate a second measurement sub-report based on an average value of the second signal interference measurements; and associate the first measurement sub-report and the second measurement sub-report with the second measurement report.

The communications manager 1104 and/or other device components may be configured as or otherwise support a means for wireless communication and/or network signaling at a UE, including generating a first measurement report that includes an indication of signal interference, and transmitting the first measurement report to a network node; receiving, from the network node, signal measurement configuration information configured for detecting interference caused by an RIS; applying the signal measurement configuration information and measuring signal attributes of signal received at the UE with the signal measurement configuration information applied; and generating a second measurement report that includes the measured signal attributes, and transmitting the second measurement report to the network node.

Additionally, wireless communication and/or network signaling at the UE includes any one or combination of: where the signal measurement configuration information includes an indication of an OFF pattern identifying time slots at which an RIS is in an OFF state, and measuring signal interference of the signal received at the UE based on the indication of the OFF pattern; and generating the second measurement report to include measurements for signal interference measured based on the indication of the OFF pattern; determining direction of arrival information for the signal received at the UE; and generating the second measurement report to include the direction of arrival information; causing the UE to measure signal interference of signal received at the UE based on: first signal interference measurements for time slots where the OFF pattern indicates that the RIS is in an OFF state; and second signal interference measurements for time slots where the OFF pattern indicates that the RIS is in an ON state; generating a first measurement sub-report based on an average value of the first signal interference measurements; generating a second measurement sub-report based on an average value of the second signal interference measurements; and associating the first measurement sub-report and the second measurement sub-report with the second measurement report.

The processor 1106 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1106 may be configured to operate a memory array using a memory controller. In some other implementations, a memory controller may be integrated into the processor 1106. The processor 1106 may be configured to execute computer-readable instructions stored in a memory (e.g., the memory 1108) to cause the device 1102 to perform various functions of the present disclosure.

The memory 1108 may include random access memory (RAM) and read-only memory (ROM). The memory 1108 may store computer-readable, computer-executable code including instructions that, when executed by the processor 1106 cause the device 1102 to perform various functions described herein. The code may be stored in a non-transitory computer-readable medium such as system memory or another type of memory. In some implementations, the code may not be directly executable by the processor 1106 but may cause a computer (e.g., when compiled and executed) to perform functions described herein. In some implementations, the memory 1108 may include, among other things, a basic I/O system (BIOS) which may control basic hardware or software operation such as the interaction with peripheral components or devices.

The I/O controller 1114 may manage input and output signals for the device 1102. The I/O controller 1114 may also manage peripherals not integrated into the device 1102. In some implementations, the I/O controller 1114 may represent a physical connection or port to an external peripheral. In some implementations, the I/O controller 1114 may utilize an operating system such as iOS®, ANDROID®, MS-DOS®, MS-WINDOWS®, OS/2®, UNIX®, LINUX®, or another known operating system. In some implementations, the I/O controller 1114 may be implemented as part of a processor, such as the processor 1106. In some implementations, a user may interact with the device 1102 via the I/O controller 1114 or via hardware components controlled by the I/O controller 1114.

In some implementations, the device 1102 may include a single antenna 1116. However, in some other implementations, the device 1102 may have more than one antenna 1116, which may be capable of concurrently transmitting or receiving multiple wireless transmissions. The receiver 1110 and the transmitter 1112 may communicate bi-directionally, via the one or more antennas 1116, wired, or wireless links as described herein. For example, the receiver 1110 and the transmitter 1112 may represent a wireless transceiver and may communicate bi-directionally with another wireless transceiver. The transceiver may also include a modem to modulate the packets, to provide the modulated packets to one or more antennas 1116 for transmission, and to demodulate packets received from the one or more antennas 1116.

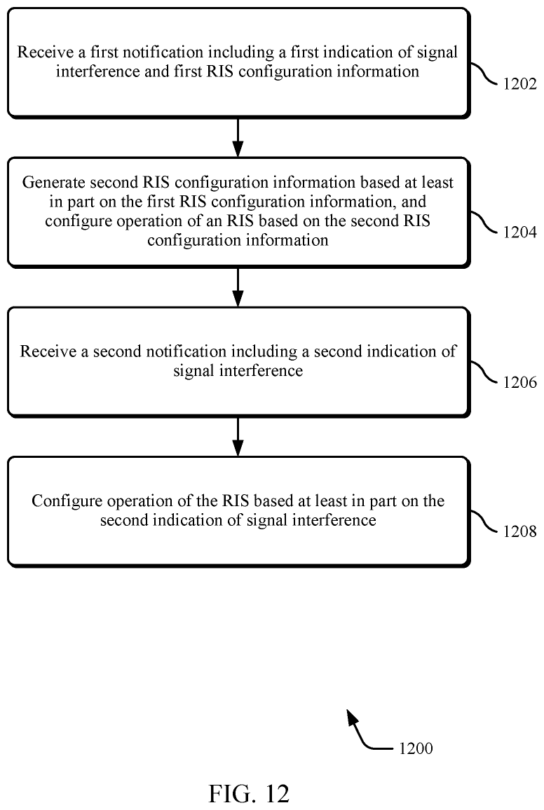

FIG. 12 illustrates a flowchart of a method 1200 that supports RIS management in wireless systems in accordance with aspects of the present disclosure. The operations of the method 1200 may be implemented and performed by a device or its components, such as a base station 102 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1202, the method may include receiving a first notification including a first indication of signal interference and first RIS configuration information. The operations of 1202 may be performed in accordance with examples as described herein. In some implementations, aspects of the operations of 1202 may be performed by a device as described with reference to FIG. 1.

At 1204, the method may include generating second RIS configuration information based at least in part on the first RIS configuration information, and configuring operation of an RIS based on the second RIS configuration information. The operations of 1204 may be performed in accordance with examples as described herein. In some implementations, aspects of the operations of 1204 may be performed by a device as described with reference to FIG. 1.

At 1206, the method may include receiving a second notification including a second indication of signal interference. The operations of 1206 may be performed in accordance with examples as described herein. In some implementations, aspects of the operations of 1206 may be performed by a device as described with reference to FIG. 1.

At 1208, the method may include configuring operation of the RIS based at least in part on the second indication of signal interference. The operations of 1208 may be performed in accordance with examples as described herein. In some implementations, aspects of the operations of 1208 may be performed by a device as described with reference to FIG. 1.

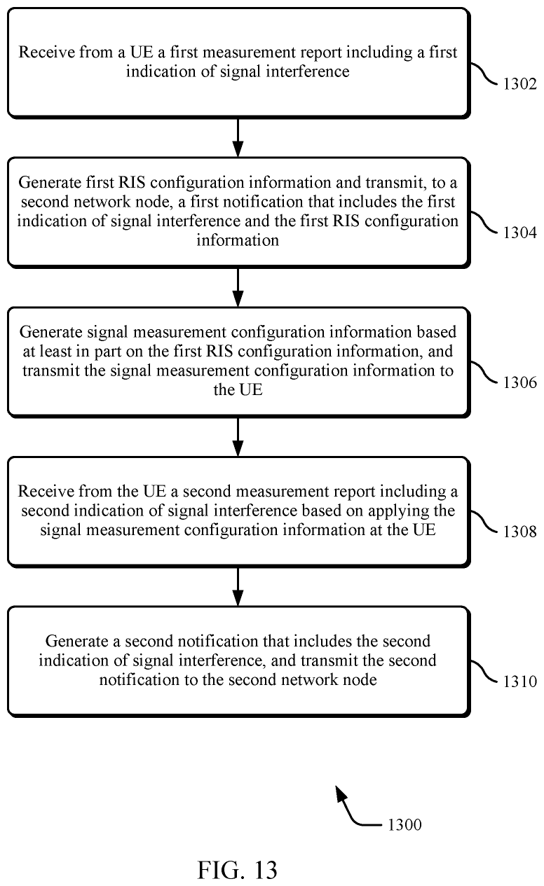

FIG. 13 illustrates a flowchart of a method 1300 that supports RIS management in wireless systems in accordance with aspects of the present disclosure. The operations of the method 1300 may be implemented and performed by a device or its components, such as a base station 102 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1302, the method may include receiving from a UE a first measurement report including a first indication of signal interference. The operations of 1302 may be performed in accordance with examples as described herein. In some implementations, aspects of the operations of 1302 may be performed by a device as described with reference to FIG. 1.

At 1304, the method may include generating first RIS configuration information and transmit, to a second network node, a first notification that includes the first indication of signal interference and the first RIS configuration information. The operations of 1304 may be performed in accordance with examples as described herein. In some implementations, aspects of the operations of 1304 may be performed by a device as described with reference to FIG. 1.

At 1306, the method may include generating signal measurement configuration information based at least in part on the first RIS configuration information, and transmitting the signal measurement configuration information to the UE. The operations of 1306 may be performed in accordance with examples as described herein. In some implementations, aspects of the operations of 1306 may be performed by a device as described with reference to FIG. 1.

At 1308, the method may include receiving from the UE a second measurement report including a second indication of signal interference based on applying the signal measurement configuration information at the UE. The operations of 1308 may be performed in accordance with examples as described herein. In some implementations, aspects of the operations of 1308 may be performed by a device as described with reference to FIG. 1.

At 1310, the method may include generating a second notification that includes the second indication of signal interference, and transmitting the second notification to the second network node. The operations of 1310 may be performed in accordance with examples as described herein. In some implementations, aspects of the operations of 1310 may be performed by a device as described with reference to FIG. 1.

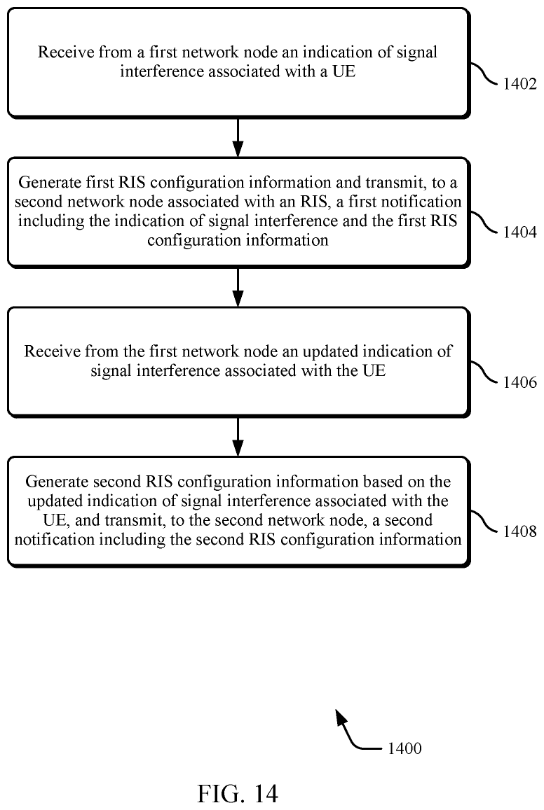

FIG. 14 illustrates a flowchart of a method 1400 that supports RIS management in wireless systems in accordance with aspects of the present disclosure. The operations of the method 1400 may be implemented and performed by a device or its components, such as an RIS control function as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1402, the method may include receiving from a first network node an indication of signal interference associated with a UE. The operations of 1402 may be performed in accordance with examples as described herein. In some implementations, aspects of the operations of 1402 may be performed by a device as described with reference to FIG. 1.

At 1404, the method may include generating first RIS configuration information and transmit, to a second network node associated with an RIS, a first notification including the indication of signal interference and the first RIS configuration information. The operations of 1404 may be performed in accordance with examples as described herein. In some implementations, aspects of the operations of 1404 may be performed by a device as described with reference to FIG. 1.

At 1406, the method may include receiving from the first network node an updated indication of signal interference associated with the UE. The operations of 1406 may be performed in accordance with examples as described herein. In some implementations, aspects of the operations of 1406 may be performed by a device as described with reference to FIG. 1.

At 1408, the method may include generating second RIS configuration information based on the updated indication of signal interference associated with the UE, and transmitting, to the second network node, a second notification including the second RIS configuration information. The operations of 1408 may be performed in accordance with examples as described herein. In some implementations, aspects of the operations of 1408 may be performed by a device as described with reference to FIG. 1.

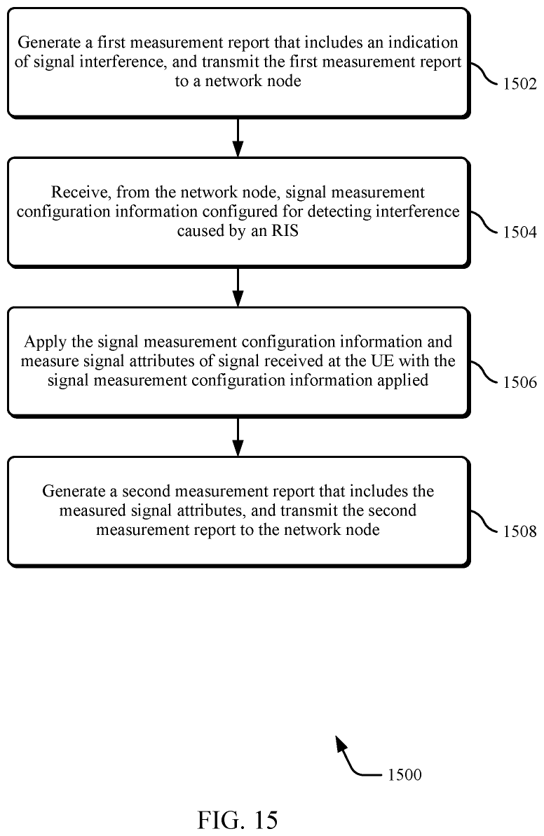

FIG. 15 illustrates a flowchart of a method 1500 that supports RIS management in wireless systems in accordance with aspects of the present disclosure. The operations of the method 1500 may be implemented and performed by a device or its components, such as a UE 104 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1502, the method may include generating a first measurement report that includes an indication of signal interference, and transmitting the first measurement report to a network node. The operations of 1502 may be performed in accordance with examples as described herein. In some implementations, aspects of the operations of 1502 may be performed by a device as described with reference to FIG. 1.

At 1504, the method may include receiving, from the network node, signal measurement configuration information configured for detecting interference caused by an RIS. The operations of 1504 may be performed in accordance with examples as described herein. In some implementations, aspects of the operations of 1504 may be performed by a device as described with reference to FIG. 1.

At 1506, the method may include applying the signal measurement configuration information and measure signal attributes of signal received at the UE with the signal measurement configuration information applied. The operations of 1506 may be performed in accordance with examples as described herein. In some implementations, aspects of the operations of 1506 may be performed by a device as described with reference to FIG. 1.

At 1508, the method may include generating a second measurement report that includes the measured signal attributes, and transmit the second measurement report to the network node. The operations of 1508 may be performed in accordance with examples as described herein. In some implementations, aspects of the operations of 1508 may be performed by a device as described with reference to FIG. 1.

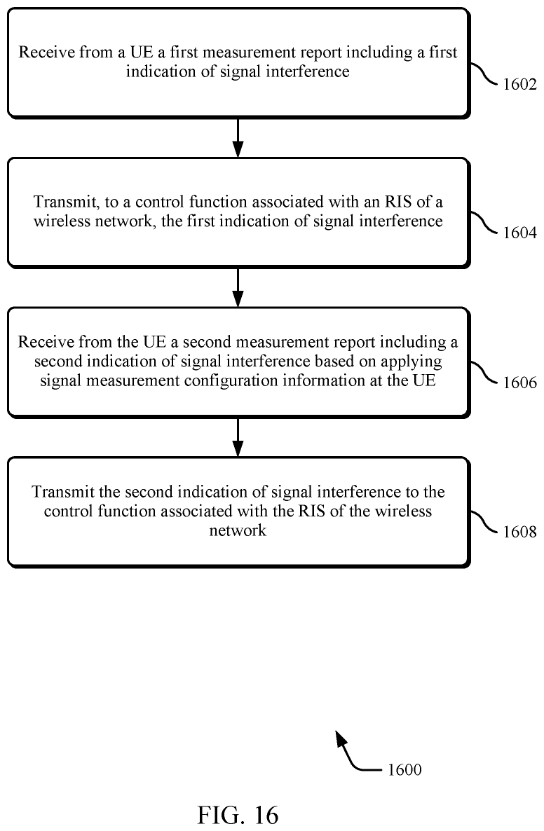

FIG. 16 illustrates a flowchart of a method 1600 that supports RIS management in wireless systems in accordance with aspects of the present disclosure. The operations of the method 1600 may be implemented and performed by a device or its components, such as a base station 102 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1602, the method may include receiving from a UE a first measurement report including a first indication of signal interference. The operations of 1602 may be performed in accordance with examples as described herein. In some implementations, aspects of the operations of 1602 may be performed by a device as described with reference to FIG. 1.

At 1604, the method may include transmitting, to a control function associated with an RIS of a wireless network, the first indication of signal interference. The operations of 1604 may be performed in accordance with examples as described herein. In some implementations, aspects of the operations of 1604 may be performed by a device as described with reference to FIG. 1.

At 1606, the method may include receiving from the UE a second measurement report including a second indication of signal interference based on applying signal measurement configuration information at the UE. The operations of 1606 may be performed in accordance with examples as described herein. In some implementations, aspects of the operations of 1606 may be performed by a device as described with reference to FIG. 1.

At 1608, the method may include transmitting the second indication of signal interference to the control function associated with the RIS of the wireless network. The operations of 1608 may be performed in accordance with examples as described herein. In some implementations, aspects of the operations of 1608 may be performed by a device as described with reference to FIG. 1.

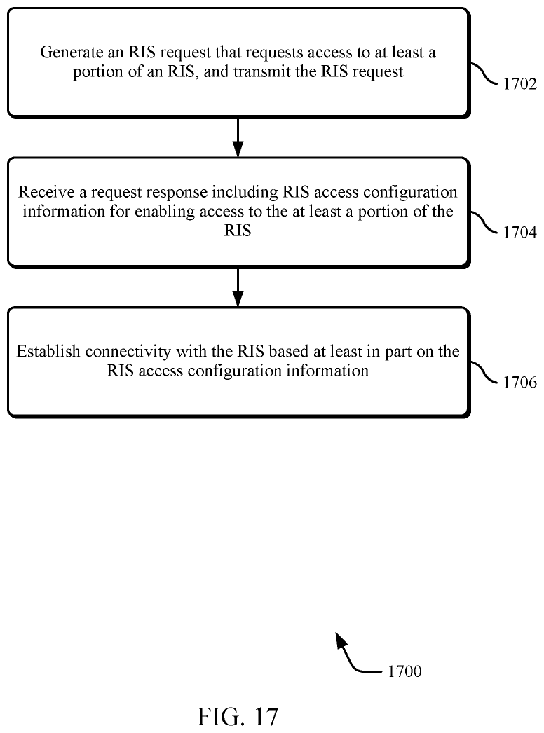

FIG. 17 illustrates a flowchart of a method 1700 that supports RIS management in wireless systems in accordance with aspects of the present disclosure. The operations of the method 1700 may be implemented and performed by a device or its components, such as a base station 102 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1702, the method may include generating an RIS request that requests access to at least a portion of an RIS, and transmitting the RIS request. The operations of 1702 may be performed in accordance with examples as described herein. In some implementations, aspects of the operations of 1702 may be performed by a device as described with reference to FIG. 1.

At 1704, the method may include receiving a request response including RIS access configuration information for enabling access to the at least a portion of the RIS. The operations of 1704 may be performed in accordance with examples as described herein. In some implementations, aspects of the operations of 1704 may be performed by a device as described with reference to FIG. 1.

At 1706, the method may include establishing connectivity with the RIS based at least in part on the RIS access configuration information. The operations of 1706 may be performed in accordance with examples as described herein. In some implementations, aspects of the operations of 1706 may be performed by a device as described with reference to FIG. 1.

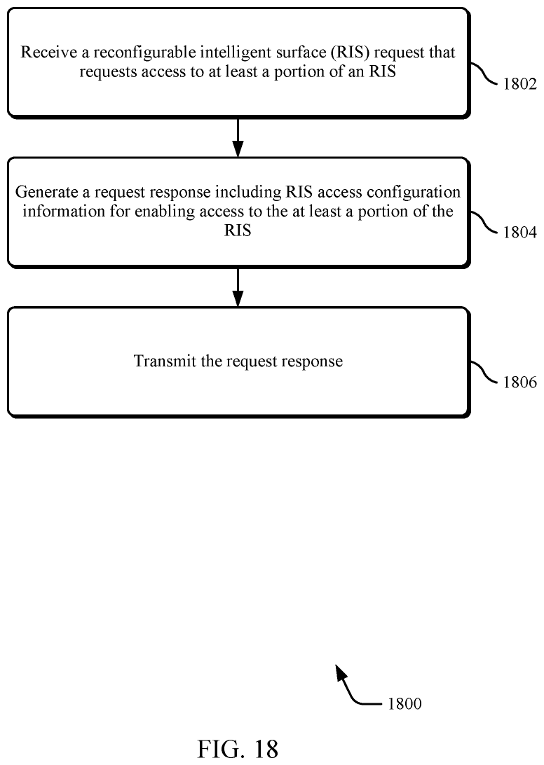

FIG. 18 illustrates a flowchart of a method 1800 that supports RIS management in wireless systems in accordance with aspects of the present disclosure. The operations of the method 1800 may be implemented and performed by a device or its components, such as a base station 102 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1802, the method may include receiving a RIS request that requests access to at least a portion of an RIS. The operations of 1802 may be performed in accordance with examples as described herein. In some implementations, aspects of the operations of 1802 may be performed by a device as described with reference to FIG. 1.

At 1804, the method may include generating a request response including RIS access configuration information for enabling access to the at least a portion of the RIS. The operations of 1804 may be performed in accordance with examples as described herein. In some implementations, aspects of the operations of 1804 may be performed by a device as described with reference to FIG. 1.

At 1806, the method may include transmitting the request response. The operations of 1806 may be performed in accordance with examples as described herein. In some implementations, aspects of the operations of 1806 may be performed by a device as described with reference to FIG. 1.

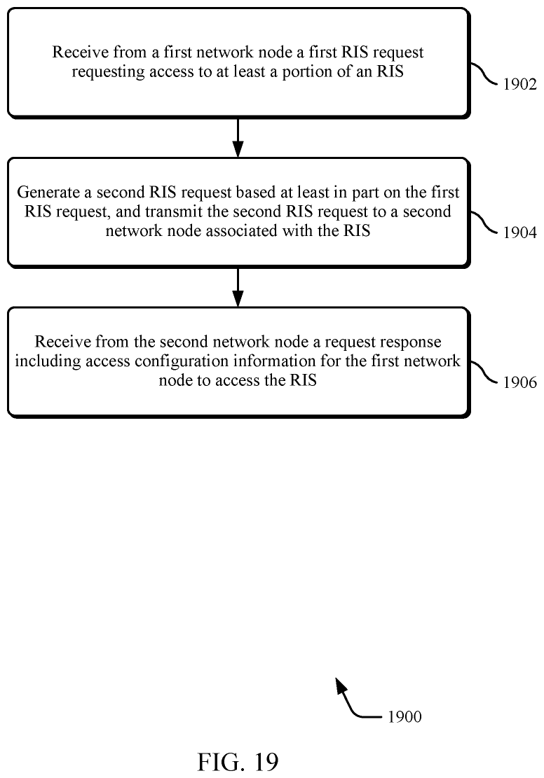

FIG. 19 illustrates a flowchart of a method 1900 that supports RIS management in wireless systems in accordance with aspects of the present disclosure. The operations of the method 1900 may be implemented and performed by a device or its components, such as a network RIS component 120 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1902, the method may include receiving from a first network node a first RIS request requesting access to at least a portion of an RIS. The operations of 1902 may be performed in accordance with examples as described herein. In some implementations, aspects of the operations of 1902 may be performed by a device as described with reference to FIG. 1.

At 1904, the method may include generating a second RIS request based at least in part on the first RIS request, and transmitting the second RIS request to a second network node associated with the RIS. The operations of 1904 may be performed in accordance with examples as described herein. In some implementations, aspects of the operations of 1904 may be performed by a device as described with reference to FIG. 1.

At 1906, the method may include receiving from the second network node a request response including access configuration information for the first network node to access the RIS. The operations of 1906 may be performed in accordance with examples as described herein. In some implementations, aspects of the operations of 1906 may be performed by a device as described with reference to FIG. 1.

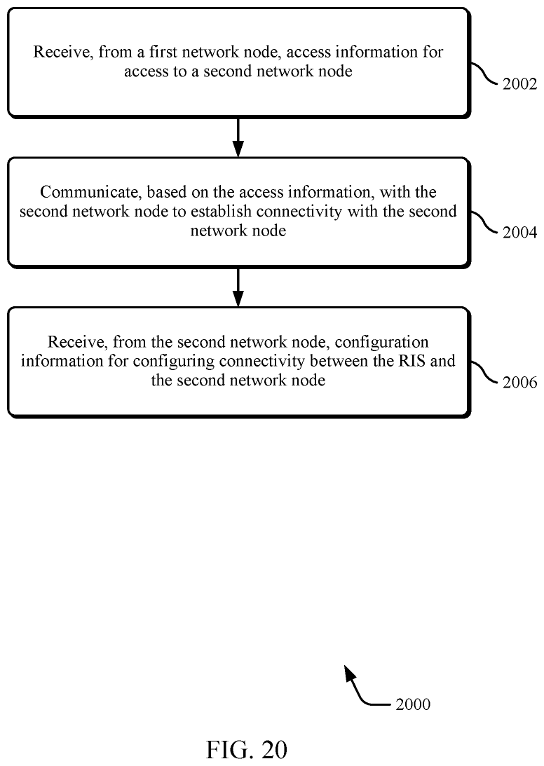

FIG. 20 illustrates a flowchart of a method 2000 that supports RIS management in wireless systems in accordance with aspects of the present disclosure. The operations of the method 2000 may be implemented and performed by a device or its components, such as an RIS 118 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 2002, the method may include receiving, from a first network node, access information for access to a second network node. The operations of 2002 may be performed in accordance with examples as described herein. In some implementations, aspects of the operations of 2002 may be performed by a device as described with reference to FIG. 1.

At 2004, the method may include communicating, based on the access information, with the second network node to establish connectivity with the second network node. The operations of 2004 may be performed in accordance with examples as described herein. In some implementations, aspects of the operations of 2004 may be performed by a device as described with reference to FIG. 1.

At 2006, the method may include receiving, from the second network node, configuration information for configuring connectivity between the RIS and the second network node. The operations of 2006 may be performed in accordance with examples as described herein. In some implementations, aspects of the operations of 2006 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
at least one memory; and
at least one processor coupled with the at least one memory and configured to cause the apparatus to:
generate a reconfigurable intelligent surface (RIS) request that requests access to at least a portion of an RIS, and transmit the RIS request;
receive a request response including RIS access configuration information for enabling access to the at least a portion of the RIS; and
establish connectivity with the RIS based at least in part on the RIS access configuration information.

2. The apparatus of claim 1, wherein the at least one processor is configured to cause the apparatus to generate the RIS request to indicate one or more of a number of instances of user equipment that are associated with the RIS request, or a target service area associated with the RIS request.

3. The apparatus of claim 1, wherein the at least one processor is configured to cause the apparatus to generate the RIS request to indicate a priority of the RIS request based on one or more of a number of instances of user equipment that are associated with the RIS request, or a target service area associated with the RIS request.

4. The apparatus of claim 1, wherein the at least one processor is configured to cause the apparatus to receive the request response as an acknowledgement response indicating permission to access the at least a portion of the RIS or a non-acknowledgement response indicating no permission to access the at least a portion of the RIS.

5. The apparatus of claim 1, wherein the at least one processor is configured to cause the apparatus to transmit the RIS request to an RIS control function at a central unit of a wireless network, and receive the request response from the RIS control function.

6. The apparatus of claim 1, wherein the at least one processor is configured to cause the apparatus to receive one or more measurement reports indicating signal quality measured at one or more instances of user equipment, and generate and transmit the RIS request based on the one or more measurement reports indicating that the signal quality is below a signal quality threshold.

7. The apparatus of claim 1, wherein the RIS access configuration information comprises one or more of time slot information for access to the RIS, or time scheduling information for time slots for access to the RIS.

8. The apparatus of claim 1, wherein the RIS access configuration information comprises an indication of a segment of the RIS that is available, and wherein the at least one processor is configured to cause the apparatus to establish connectivity with the RIS and utilize the segment of the RIS for connectivity with one or more UEs.

9. An apparatus for wireless communication, comprising:
at least one memory; and
at least one processor coupled with the at least one memory and configured to cause the apparatus to:
receive a reconfigurable intelligent surface (RIS) request that requests access to at least a portion of an RIS;
generate a request response including RIS access configuration information for enabling access to the at least a portion of the RIS; and
transmit the request response.

10. The apparatus of claim 9, wherein the RIS request comprises one or more of a number of instances of user equipment that are associated with the RIS request, a target service area associated with the RIS request, or a priority of the RIS request.

11. The apparatus of claim 9, wherein the apparatus comprises a first network node, the RIS request identifies a second network node, and wherein the at least one processor is configured to cause the apparatus to transmit a connection notification to the RIS to establish a connection with the second network node.

12. The apparatus of claim 11, wherein the at least one processor is configured to cause the apparatus to transmit a termination notification to the RIS to terminate a connection to the first network node.

13. The apparatus of claim 11, wherein the at least one processor is configured to cause the apparatus to generate the connection notification to include connectivity information for connecting the RIS to the second network node.

14. The apparatus of claim 9, wherein the RIS request is received from an RIS control function at a central unit of a wireless network, and wherein the at least one processor is configured to cause the apparatus to transmit the request response to the RIS control function at the central unit.

15. The apparatus of claim 14, wherein the apparatus comprises a first network node associated with the RIS, and the RIS request includes an instruction from the RIS control function for the first network node to cause the RIS to establish connectivity with a second network node.

16. The apparatus of claim 9, wherein the at least one processor is configured to cause the apparatus to:
determine, based on one or more measurement reports from one or more user equipment, that the at least a portion of the RIS is allocatable; and
generate the request response to indicate that the at least a portion of the RIS is available.

17. The apparatus of claim 9, wherein the at least one processor is configured to cause the apparatus to:
determine that the RIS is to be segmented into multiple segments; and
transmit a notification to the RIS to segment the RIS into multiple segments and to establish connectivity with multiple network nodes via the multiple segments.

18. An apparatus associated with a control function of a wireless network for wireless communication, the apparatus comprising:
at least one memory; and
at least one processor coupled with the at least one memory and configured to cause the apparatus to:
receive from a first network node a first reconfigurable intelligent surface (RIS) request requesting access to at least a portion of an RIS;
generate a second RIS request based at least in part on the first RIS request, and transmit the second RIS request to a second network node associated with the RIS; and
receive from the second network node a request response including access configuration information for the first network node to access the RIS.

19. The apparatus of claim 18, wherein the at least one processor is configured to cause the apparatus to generate a second request response that includes at least some of the access configuration information, and transmit the second request response to the first network node.

20. (canceled)

21. A method performed by an apparatus, the method comprising:
generating a reconfigurable intelligent surface (RIS) request that requests access to at least a portion of an RIS, and transmit the RIS request;
receiving a request response including RIS access configuration information for enabling access to the at least a portion of the RIS; and
establishing connectivity with the RIS based at least in part on the RIS access configuration information.
